(19) United States
(12) Patent Application Publication
(10) Pub. No.: US 2008/0024923 A1
(43) Pub. Date: Jan. 31, 2008

(54) Lubricant film forming method, slide body with lubricant film, magnetic recording medium, magnetic head slider, and hard disk drive

(75) Inventors: Makoto Tomimoto, Hong Kong (CN); Ryuta Murakoshi, Hong Kong (CN); Zhi Su Li, Hong Kong (CN); Hiroshi Kiyono, Tokyo (JP)

Correspondence Address: OLIFF & BERRIDGE, PLC, P.O. BOX 320850, ALEXANDRIA, VA, 22320-4850, US

(73) Assignees: TDK CORPORATION, TOKYO (JP); SAE MAGNETICS (H.K) LTD., HONG KONG (CN)

(21) Appl. No.: 11/727,856

(22) Filed: Mar. 28, 2007

(30) Foreign Application Priority Data
May 24, 2006 (JP) 2006-144499
Aug. 28, 2006 (JP) 2006-231153

(51) Int. Cl. G11B 5/60

(52) U.S. Cl. 360/235.8; 428/831.2

(57) ABSTRACT

A lubricant film forming method has a step of irradiating a lubricant with an OH group laid on a surface of a base material, with infrared laser light that excites vibration of an OH bond of the OH group. In this method, the irradiation with the infrared laser light excites vibration of the OH bond of the OH group in the lubricant. Therefore, it enhances reactivity between the OH group of the lubricant and the surface of the base material, facilitates chemical bonding of the lubricant to the surface of the base material, and enhances durability of the lubricant.

### BACKGROUND OF THE INVENTION

1. Field of the Invention

The present invention relates to a lubricant film forming method, a slide body with a lubricant film, a magnetic recording medium, a magnetic head slider, and a hard disk drive.

2. Related Background Art

It is necessary to form a lubricant film on a surface (sliding surface) of a base material that comes or can come into contact such as sliding contact with another member, e.g., a surface of a hard disk (magnetic recording medium), a surface of a magnetic head slider, etc. in a hard disk drive.

There are, for example, the following known methods: lubricant film forming methods including a method of applying a lubricant to the surface of the base material and then heating it to fix the lubricant to the surface of the base material, as disclosed in Japanese Patent Applications Laid-Open No. 11-203670, Laid-Open No. 2001-93141, Laid-Open No. 2000-322734, and Laid-Open No. 2003-228810, a method of applying a lubricant to the surface of the base material and irradiating it with UV, as disclosed in Japanese Patent Application Laid-Open No. 11-25452, a method of applying a lubricant to the surface of the base material and then irradiating it with neutral radicals, as disclosed in Japanese Patent Application Laid-Open No. 6-215367, a method of modifying a surface of a lubricant layer with a plasma, gas, or the like during or after formation of the lubricant layer on the surface of the base material, as disclosed in Japanese Patent Applications Laid-Open No. 7-326151, Laid-Open No. 2004-152462, and Laid-Open No. 2002-109718, a method of applying a lubricant with a polar group onto the surface of the base material, as disclosed in Japanese Patent Applications Laid-Open No. 6-44558, Laid-Open No. 5-143975, Laid-Open No. 5-189752, Laid-Open No. 5-205246, and Laid-Open No. 6-172479, and a method of applying a lubricant and then irradiating the lubricant with a laser of not more than 300 nm to ablate part of the lubricant and to form a thin film thereof, as described in Japanese Patent Application Laid-Open No. 11-66555; lubricant film forming methods including a method of forming a self-assembled monolayer film on the surface of the base material and then making the self-assembled monolayer film adsorb the lubricant, as described in Japanese Patent Application Laid-Open No. 2005-187656; and so on.

### SUMMARY OF THE INVENTION

However, the conventional methods were not satisfactory in terms of fixing of the lubricant to the base material and durability of the lubricant film.

The present invention has been accomplished in view of the above problem and an object of the invention is to provide a method of forming a lubricant film capable of exhibiting sufficient durability and to provide a method of producing a magnetic recording medium or a magnetic head slider, using it.

A lubricant film forming method according to the present invention comprises a step of irradiating a lubricant with an OH group laid on a surface of a base material, with infrared laser light that excites vibration of an OH bond of the OH group.

According to the present invention, the irradiation with the infrared laser light excites the vibration of the OH bond of the OH group in the lubricant. Therefore, it enhances reactivity between the OH group of the lubricant and the surface of the base material, facilitates chemical bonding of the lubricant to the surface of the base material, and enhances the durability of the lubricant.

Specifically, the following mechanism can be contemplated. Namely, there are terminal bonds, called dangling bonds, in the surface of the base material. Normally, the dangling bonds exist in the following states: a state in which a dangling bond is not bound to another atom, a state in which a dangling bond is bound to an OH group, a state in which a dangling bond is hydrogen-bound (adsorbed) to a water molecule, and so on. According to the invention as described above, the irradiation with the laser light excites the vibration of the OH bond of the OH group in the lubricant whereby the OH group is activated and becomes more reactive; therefore, the OH group becomes more likely to be bound to a dangling bond in the surface of the base material. Therefore, the lubricant can be readily covalently bound, for example, through the hydroxyl-derived O atom to the dangling bonds in the surface of the base material. Hence, the durability of the lubricant film is enhanced.

Preferably, the step comprises irradiating the lubricant with the infrared laser light of wavelengths of 0.9-8 μm, or making the lubricant absorb an energy corresponding to the light of wavelengths of 0.9-8 μm by multiphoton absorption with the infrared laser light. Particularly preferably, the step comprises irradiating the lubricant with the infrared laser light of wavelengths of 0.9-1.1 μm or of wavelengths of 2.7-3.0 μm, or making the lubricant absorb an energy corresponding to light of wavelengths of 0.9-1.1 μm or of wavelengths of 2.7-3.0 μm by multiphoton absorption with the infrared laser light.

Preferably, the step comprises irradiating the lubricant with the infrared laser light so as to implement multiphoton absorption and focus the infrared laser light on the surface of the base material or on a portion of the lubricant on the base material side.

This can selectively excite the OH group of the lubricant near the surface of the base material, based on the absorption of the infrared light, and thus suppress unwanted side reactions and others in the region other than the interface, which is preferred. In the multiphoton absorption there is little absorption of light in the region other than the focal spot, and it is thus feasible to adequately implement the absorption even if the film made of the lubricant is thick.

Preferably, the infrared laser light used is infrared laser light having passed through a homogenizer. In this case, the homogenizer makes an intensity distribution of the laser light flat in plane and it is thus feasible to process a wide area quickly at a uniform irradiation intensity.

Preferably, the lubricant is a layer having a thickness of not more than 2 nm.

This permits the infrared laser light to adequately reach, particularly, the region near the interface between the lubricant and the base material, and thus the infrared laser light is efficiently absorbed by the OH group of the lubricant located near the surface of the base material.

Preferably, an irradiation intensity of the infrared laser light is not more than 60 J/cm².

If the irradiation intensity is over 60 J/cm², it can damage the lubricant or the surface of the base material.

Specifically, a preferred configuration is, for example, a configuration wherein the infrared laser light for irradiation is an infrared pulsed laser beam and wherein the laser beam has an irradiation intensity of not more than 60 J/cm², a pulse width of 0.1-1 ms, a pulse number of 1-10, and a frequency of pulses of 10-50 Hz.

Preferably, a surface temperature of the base material is kept not more than 200° C. during the irradiation with the infrared laser.

If the surface temperature of the base material is over 200° C., there can occur evaporation or deterioration of the lubricant, and there can occur deterioration of the base material.

Preferably, the lubricant is a fluorinated organic compound with an OH group. Particularly preferably, the lubricant is a fluorinated organic compound with an OH group at a terminal.

A lubricant of the fluorinated organic compound type has high lubricating performance, but it was difficult to fix it to the base material by the conventional technology. However, the present invention allows such a lubricant to be adequately fixed to the base material, and thus facilitates formation of a lubricant film with excellent lubricating performance and durability.

Preferably, the surface of the base material is made of a carbon material. Particularly, the carbon material has sufficient performance as a protecting film for the surface, but it was difficult to fix the lubricant because it was a chemically stable substance. However, the present invention permits the lubricant to be adequately fixed even to the surface of the base material made of the carbon material.

A production method of a magnetic recording medium according to the present invention comprises performing the above-described lubricant film forming method, for a lubricant laid on a surface of a magnetic recording medium.

A production method of a magnetic head slider according to the present invention comprises performing the above-described lubricant film forming method, for a lubricant laid on a surface of a magnetic head slider.

The present invention provides the forming method of the lubricant film capable of exhibiting satisfactory durability and provides the production method of the magnetic recording medium or the magnetic head slider using it.

Another object of the present invention is to provide a method of forming a lubricant film fixed to only a portion of a surface of a base material and having satisfactory durability. A further object of the invention is to provide a slide body, a magnetic recording medium, a magnetic head slider, and a hard disk drive wherein a lubricant is fixed to only a portion of a sliding surface.

A lubricant film forming method according to the present invention comprises a laser light irradiation step of irradiating only a portion of a surface of a base material coated with a lubricant having an OH group bound to a carbon atom, with infrared laser light that excites vibration of an OH bond of the OH group, to form a lubricant film on only the portion of the surface of the base material.

In the lubricant film forming method according to the present invention, the irradiation with the infrared laser light excites the vibration of the OH bond of the OH group in the lubricant. Therefore, it enhances reactivity between the OH group of the lubricant and the surface of the base material, facilitates binding of the lubricant to the surface of the base material through a covalent bond, and enhances the durability of the resultant lubricant film.

Specifically, the following mechanism can be contemplated. Namely, there are terminal bonds, called dangling bonds, in the surface of the base material. Normally, the dangling bonds exist in the following states: a state in which a dangling bond is not bound to another atom, a state in which a dangling bond is bound to an OH group, a state in which a dangling bond is hydrogen-bound (adsorbed) to a water molecule, and so on. According to the invention as described above, the irradiation with the laser light excites the vibration of the OH bond of the OH group in the lubricant whereby the OH group is activated and becomes more reactive; therefore, the OH group becomes more likely to be bound to a dangling bond in the surface of the base material. Therefore, the lubricant can be readily covalently bound, for example, through the O atom derived from the OH group bound to a carbon atom, to the dangling bonds in the surface of the base material. Hence, the lubricant film is bonded more firmly to the surface of the base material, and the durability of the lubricant film is enhanced.

Furthermore, the lubricant film forming method according to the present invention permits only a portion of the surface of the base material to be irradiated with the laser light, whereby the lubricant in the portion irradiated with the laser light can be selectively bound covalently to the dangling bonds in the surface of the base material; therefore, it is easy to obtain a lubricant film fixed to only a portion of the surface of the base material. Accordingly, unevenness due to the lubricant film can be readily formed in the surface of the base material. Since the lubricant film can be formed on only a desired portion, it is easy to perform quality management of the lubricant film.

Preferably, the laser light irradiation step comprises irradiating the lubricant with the infrared laser light of wavelengths of 0.9-8 μm, or making the lubricant absorb an energy corresponding to the light of wavelengths of 0.9-8 μm by multiphoton absorption with the infrared laser. Particularly preferably, the laser light irradiation step comprises irradiating the lubricant with the infrared laser light of wavelengths of 0.9-1.1 μm or of wavelengths of 2.7-3.0 μm, or making the lubricant absorb an energy corresponding to light of wavelengths of 0.9-1.1 μm or of wavelengths of 2.7-3.0 μm by multiphoton absorption with the infrared laser.

Preferably, the laser light irradiation step comprises irradiating the lubricant with the infrared laser light so as to implement multiphoton absorption and focus the infrared laser light on the surface of the base material or on a portion of the lubricant on the base material side.

This can selectively excite the OH group of the lubricant near the surface of the base material, based on the absorption of the infrared light, and thus suppress unwanted side reactions and others in the region other than the interface, which is preferred. In the multiphoton absorption there is little absorption of light in the region other than the focal spot, and it is thus feasible to adequately implement the absorption even if the lubricant layer made of the lubricant is thick.

Preferably, the infrared laser light used is infrared laser light having passed through a homogenizer. In this case, the homogenizer makes an intensity distribution of the laser light flat in plane and it is thus feasible to process a wide area quickly at a uniform irradiation intensity.

Preferably, a layer of the lubricant laid on the surface of the base material has a thickness of not more than 2 nm.

This permits the infrared laser light to adequately reach, particularly, the region near the interface between the lubricant and the base material, and thus the infrared laser light is efficiently absorbed by the OH group of the lubricant located near the surface of the base material.

Preferably, an irradiation intensity of the infrared laser light is not more than 60 J/cm².

If the irradiation intensity is over 60 J/cm², it can damage the lubricant or the surface of the base material.

Specifically, a preferred configuration is, for example, a configuration wherein the infrared laser light for irradiation is an infrared pulsed laser beam and wherein the infrared pulsed laser beam has an irradiation intensity of not more than 60 J/cm², a pulse width of 0.1-1 ms, a pulse number of 1-10, and a frequency of pulses of 10-50 Hz.

Preferably, in the laser light irradiation step, a surface temperature of the base material is kept not more than 200° C.

If the surface temperature of the base material is over 200° C., there can occur evaporation or deterioration of the lubricant, and there can occur deterioration of the base material.

Preferably, the lubricant is a fluorinated organic compound.

When the lubricant is a fluorinated organic compound, it demonstrates high lubricating performance and water repellency, but it was difficult to fix it to the base material by the conventional technology. However, the present invention permits such a lubricant to be adequately fixed to the base material and it is thus easy to form the lubricant film with excellent lubricating performance and durability.

Preferably, the surface of the base material is made of a carbon material. Particularly, a carbon material has sufficient performance as a protecting film for the surface, but it was difficult to fix the lubricant because it was a chemically stable substance. However, the present invention permits the lubricant to be adequately fixed even to the surface of the base material made of the carbon material.

The foregoing lubricant film is preferably a plurality of dot patterns and the diameter of the dot patterns is preferably 0.9-100 μm.

This can reduce the contact area when the lubricant film is in contact with another member. Furthermore, where there is a further lubricant layer on the surface of the base material, the fluidity of the lubricant can be controlled by anchor effect of the dot patterns.

The lubricant film forming method of the present invention preferably further comprises a cleaning step of removing the lubricant not fixed to the surface of the base material, after the laser light irradiation step.

This obtains the lubricant film in which the flowing lubricant rarely exists in the surface of the base material.

Furthermore, the lubricant film forming method of the present invention preferably further comprises a second lubricant application step of applying the lubricant to the surface of the base material, after the cleaning step.

This can form unevenness in the surface of the layer of the lubricant applied.

A slide body according to the present invention is a slide body wherein a lubricant film is formed on only a portion of a sliding surface, wherein a molecule forming the lubricant film has a C—O bond, and wherein an O atom of the C—O bond is bound through a covalent bond to an atom of the sliding surface.

In the slide body according to the present invention, the lubricant film is formed on only a portion of the sliding surface, so that the lubrication characteristic of the sliding surface can be freely changed in a certain range. Furthermore, since the slide body according to the present invention has sufficiently high durability of the lubricant film, the lubricant film can be adequately prevented from dropping off the sliding surface when the sliding surface comes into contact with another member and slides thereon because of vibration, impact, or the like. Furthermore, in the slide body according to the present invention, unevenness due to the lubricant film can be formed in the surface of the base material. In addition, since the lubricant film can be formed on only the desired portion, it is easy to perform quality management of the lubricant film.

The slide body according to the present invention can be readily formed by the aforementioned lubricant film forming method.

Preferably, the molecule forming the lubricant film has an organic group containing a plurality of fluorine atoms.

When the lubricant film is comprised of the molecule with the organic group containing fluorine atoms, high lubricating performance is exhibited and, therefore, the slide body with such a lubricant film demonstrates excellent lubricating performance.

The sliding surface is preferably made of a carbon material. This results in adequately protecting the sliding surface.

The lubricant film is preferably a plurality of dot patterns, and the diameter of the dot patterns is preferably 0.9-100 μm.

In this configuration, unevenness is formed in the sliding surface, so as to achieve water repellent effect, whereby water droplets become unlikely to attach to the sliding surface even under high humidity.

Preferably, the slide body has a lubricant layer wherein lubricant molecules physically adsorb to a portion without the dot patterns on the sliding surface and to surfaces of the dot patterns.

In this configuration, fluidity of the lubricant can be controlled by anchor effect of the dot patterns.

Preferably, a surface of the lubricant layer in a portion with the dot patterns is more outwardly projecting than a surface of the lubricant layer in the portion without the dot patterns.

This improves the anchor effect by the dot patterns, whereby the fluidity of the lubricant can be controlled at a higher level.

A magnetic recording medium according to the present invention comprises the above-described slide body and has a magnetic recording layer in the slide body.

The magnetic recording medium is preferably configured as follows: the slide body is of a disk shape, and the lubricant film is formed in an annular region located in at least one of a radially inside portion, a radially middle portion, and a radially outside portion in the sliding surface of the disk shape.

A magnetic head slider according to the present invention comprises the above-described slide body and has a magnetic recording element and/or a magnetic reading element disposed relative to the sliding surface.

In the magnetic head slider according to the present invention, preferably, the sliding surface has a bottom portion and a first projection projecting from the bottom portion, and the lubricant film is provided on a surface of either one of the bottom portion and the first projection.

In the magnetic head slider according to the present invention, preferably, the sliding surface includes a bottom portion, a first projection projecting from the bottom portion, and a second projection provided around the first projection and being lower than the first projection and higher than the bottom portion, and the lubricant film is provided on a surface of at lease one of the first projection, the bottom portion, and the second projection.

The magnetic head slider according to the present invention preferably comprises the lubricant film on a surface of a sensor section including the foregoing magnetic recording element and/or magnetic reading element.

A hard disk drive according to the present invention comprises the aforementioned magnetic recording medium and magnetic head slider.

The present invention provides the forming method of the lubricant film fixed to only a portion of the surface of the base member and having sufficient durability. Furthermore, the present invention provides the slide body, the magnetic recording medium, the magnetic head slider, and the hard disk drive wherein the lubricant is fixed in only a portion of the sliding surface.

### BRIEF DESCRIPTION OF THE DRAWINGS

FIG. 1 is a schematic sectional view showing a preferred embodiment of the present invention.

FIG. 2 is a schematic sectional view subsequent to FIG. 1, showing the preferred embodiment of the present invention.

FIG. 3 is a graph showing an absorption wavelength distribution of an OH bond of an OH group.

FIG. 4 shows examples of laser irradiation systems, wherein (a) shows an irradiation system for enlarging a laser beam into a spot of a predetermined area and (b) an irradiation system for focusing a laser beam.

FIG. 5 is a schematic sectional view subsequent to FIG. 2, showing the preferred embodiment of the present invention.

FIG. 6 is a schematic sectional view subsequent to FIG. 5, showing the preferred embodiment of the present invention.

FIG. 7 is a schematic view showing a hard disk device according to the present invention.

FIG. 8 is partial sectional views of FIG. 7, wherein (a) is a sectional view of a slider and (b) a sectional view of a magnetic recording medium.

FIG. 9 is a table showing conditions and results of scratch tests of Examples A1-A3 and Comparative Example A1.

FIG. 10 is a graph showing concentrations (densities) of the lubricant fixed to the surface of the base material in Example A3 and in Comparative Example A1.

FIG. 11 is a schematic sectional view showing a preferred embodiment of the present invention.

FIG. 12 is a schematic sectional view subsequent to FIG. 11, showing the preferred embodiment of the present invention.

FIG. 13 is a graph showing an absorption wavelength distribution of an OH bond of an OH group.

FIG. 14 shows examples of laser irradiation systems, wherein (a) shows an irradiation system for enlarging a laser beam into a spot of a predetermined area and (b) an irradiation system for focusing a laser beam.

FIG. 15 is a schematic sectional view showing another preferred embodiment of the present invention.

FIG. 16 is a schematic sectional view subsequent to FIG. 12, showing the preferred embodiment of the present invention.

FIG. 17 is a schematic sectional view subsequent to FIG. 16, showing the preferred embodiment of the present invention.

FIG. 18 is a schematic sectional view subsequent to FIG. 17, showing the preferred embodiment of the present invention.

FIG. 19 is a schematic view showing a hard disk device according to a preferred embodiment of the present invention.

FIG. 20 is a partial sectional view of a magnetic recording medium according to a preferred embodiment of the present invention.

FIG. 21 is plan views of magnetic recording media of a CSS method according to a preferred embodiment of the present invention.

FIG. 22 is plan views of magnetic recording media of a load-unload method according to a preferred embodiment of the present invention.

FIG. 23 is a schematic sectional view of a magnetic head slider according to a preferred embodiment of the present invention.

FIG. 24 is a perspective view of a magnetic head slider according to a preferred embodiment of the present invention.

FIG. 25 is a plan view of the magnetic head slider according to the preferred embodiment of the present invention.

FIG. 26 is a plan view of a magnetic head slider according to a preferred embodiment of the present invention.

FIG. 27 is a plan view of a magnetic head slider according to a preferred embodiment of the present invention.

FIG. 28 is a plan view of a magnetic head slider according to a preferred embodiment of the present invention.

FIG. 29 is a table showing conditions and results of scratch tests of Examples B1-B4 and Comparative Example B1.

FIG. 30 is a graph showing concentrations (densities) of the lubricant fixed to the surface of the base material in Example B3 and in Comparative Example B1.

### DESCRIPTION OF THE PREFERRED EMBODIMENTS

The preferred embodiments of the present invention will be described below with reference to the drawings. In the description of the drawings, the same elements will be denoted by the same reference symbols, without redundant description. It is noted that dimensional ratios in the drawings do not always agree with those in the description.

### First Embodiment

(Base Material Preparation Step)

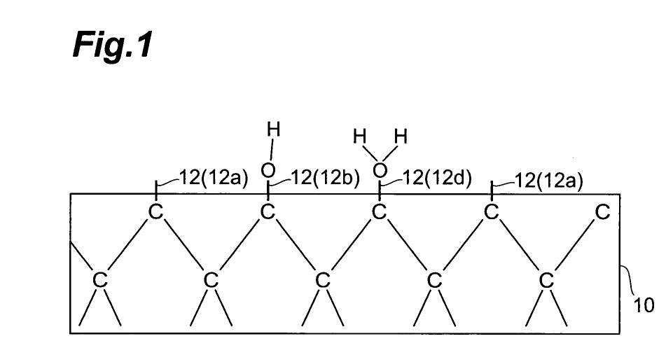

First, a base material 10 as an object to be processed is prepared, as shown in FIG. 1. There are no particular restrictions on what the base material 10 is made of. For example, the material can be selected from metals such as aluminum, aluminum alloy, and titanium; metal oxides such as alumina; ceramics such as AlTiC (Al₂O₃—TiC); inorganic materials such as silicon, glass, and carbon materials (amorphous carbon); polymer compounds such as polyethylene terephthalate, polyimide, polyamide, polycarbonate, polysulfone, polyethylene naphthalate, polyvinyl chloride, and cyclic hydrocarbon group-containing polyolefins; and so on. A film of at least one selected from NiP, NiP alloy, and other alloys can be formed on the surface of these base materials by physical vapor deposition (PVD) such as sputtering or vacuum vapor deposition, or by electroplating or the like. It is a matter of course that the base material 10 may be a multilayer structure.

The present embodiment will describe an example where the base material 10 used is diamond-like carbon (amorphous carbon) being a carbon-based protecting film prepared by CVD (chemical vapor deposition).

Normally, there are terminal bonds, called dangling bonds 12, in the surface of the base material 10. The dangling bonds 12 include those 12a not bound to any other atom, those 12b bound to an OH group, those 12c hydrogen-bound (adsorbed) to a water molecule, and so on. Of course, there are dangling bonds bound (adsorbed) to molecules other than those.

Such dangling bonds 12 appear not only in carbon materials, but also in all types of solid materials. The dangling bonds are prominently seen, particularly, in materials with a strong covalently binding property.

Prior to a lubricant application step, it is preferable to detach molecules (e.g., water or the like) or functional groups (e.g., OH groups, or the like) bound to the dangling bonds 12, for example, by heating the base material 10 (e.g., at 80-200° C. and for 30 minutes or more), by irradiating the surface of the base material 10 with ultraviolet rays (e.g., at the wavelength of 50-350 nm), or by keeping the base material 10 under a reduced pressure atmosphere (e.g., 1×10⁻¹ Torr or less), under an inert gas atmosphere (e.g., nitrogen, argon, or the like), or under a low moisture environment (e.g., RH 10% or less). The heating and the irradiation with ultraviolet rays are preferably carried out in vacuum or in an inert gas such as nitrogen or argon, or in a low moisture environment (RH 10% or less). It is needless to mention that the present invention can be carried out even if there remain molecules and functional groups bound to the dangling bonds. It is preferable to adopt a heating temperature or an intensity of UV irradiation not to cause damage to the base material.

It is also preferable to remove organic substances and the like on the surface by an ozone treatment.

(Lubricant Application Step)

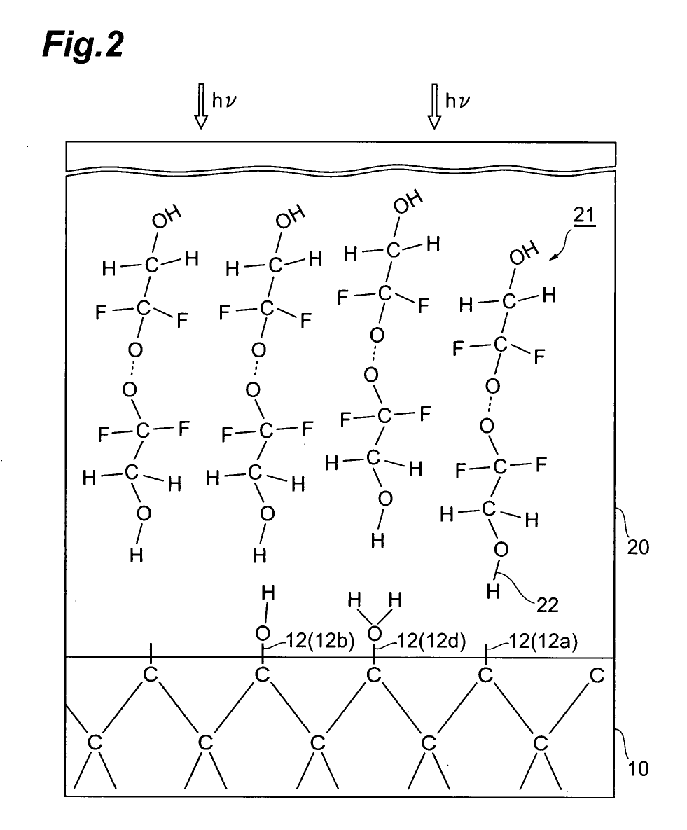

Subsequently, as shown in FIG. 2, a lubricant 21 is applied onto the surface of the base material 10 to form a lubricant film. The lubricant 21 can be any compound with an OH group. The OH group herein is a concept embracing the OH group included in complicated functional groups such as a carboxyl group (—COOH) and a phenolic group.

Examples of the lubricant 21 include hydrocarbons with an OH group and the following compounds: alcohols (e.g., erucyl alcohol, ricinolyl alcohol, arachidyl alcohol, capryl alcohol, capric alcohol, polyolefin alcohol, 2-ethylhexyl alcohol, polyalkylene glycol, etc.); carboxylic acids (e.g., aliphatic carboxylic acids, aromatic carboxylic acids, oxo carboxylic acids, etc.); esters with an OH group (e.g., thioesters, phosphoric esters, nitric esters, etc. with an OH group); ethers with an OH group (e.g., polyphenylethers, dimethyl ether, ethyl methyl ether, diethyl ether, etc. with an OH group); silicon compounds with an OH group (e.g., silicone oil with an OH group, etc.); halogenated organic compounds with an OH group (halogenated ethers with an OH group, halogenated alcohols with an OH group, halogenated carboxylic acids with an OH group, etc.). Particularly, it is preferable to use a fluorinated organic compound with an OH group; for example, examples of such fluorinated organic compounds include fluoroethers with an OH group such as perfluoropolyethers with an OH group, fluoroalcohols, carboxylic fluorides, carboxylic fluoride-alkyl esters with an OH group, fluorodiester-dicarboxylic acid compounds with an OH group, fluoromonoester-monocarboxylic acid compounds with an OH group, and so on. Among these, it is particularly preferable to use a chain halogenated organic compound with an OH group at a terminal and it is particularly preferable to use a chain fluorinated organic compound.

In particular, fluoropolyethers with an OH group are preferably adopted among the fluoroethers with an OH group and, in particular, it is particularly preferable to use one of chain fluoropolyethers with an OH group at a terminal, such as compounds represented by Formula (1) and known as Fomblin Z, compounds represented by Formula (2) and known as Fomblin Y, compounds represented by Formula (3) and known as Krytox, and compounds represented by Formula (4) and known as Demnum.

X—CF₂—O(—CF₂—CF₂—O—) ₘ(—CF₂—O—)ₙCF₂—X (1)

X—CF₂—O(—CF(CF₃)—CF₂—O—)ₘ(—CF₂—O—)ₙCF₂—X (2)

X—CF₂—O(—CF(CF₃)—CF₂—O—)ₘCF₂—CF₂—X (3)

X—CF₂—CF₂—O(—CF₂—CF₂—CF₂—O—)ₘCF₂—X (4)

In these formulae, each of n and m represents an integer of not less than 1. X represents a functional group selected from the group consisting of —CF₃, —CH₂—OH, —CH₂(—O—CH₂—CH₂—)ₚ—OH, —CH₂—O—CH(OH)—CH₂—OH, and each compound has a functional group including at least one OH group. Here P indicates an integer of not less than 1. There are no particular restrictions on the molecular weight of the chain fluoropolyethers, but the center molecular weight is preferably approximately from 500 to 4000.

It is also needless to mention that the lubricant may contain a compound without an OH group, e.g., a solvent or the like.

The application of the lubricant can be implemented by one of the known methods; e.g., vacuum vapor deposition, PVD, CVD, immersion (dipping), spin coating, spray coating, and so on. In the case where the cleaning treatment such as the heating or UV irradiation in vacuum or in inert gas is carried out for the surface of the base material 10 before the application of the lubricant, as described in the base material preparation step, this application is preferably carried out in vacuum or in inert gas in order to prevent the surface of the cleaned base material 10 from being contaminated by oxygen or water in the atmosphere, other impurities (contaminants) with high reactivity, and so on during the application.

There are no particular restrictions on the thickness of the lubricant film 20 applied herein, but the thickness is preferably approximately 2 nm or less, so as to permit the infrared laser to efficiently reach, particularly, the interface between the base material 10 and the lubricant film 20 and the vicinity thereof. In the case of multiphoton absorption, there are no particular restrictions on the film thickness.

The lubricant film 20 may be heated (e.g., at 80-200° C. and for 30 minutes or more) or the lubricant film 20 may be irradiated with UV, if necessary, after the application of the lubricant 21 so that the OH group of the lubricant 21 or a functional group except for the OH group (e.g., an amino group) can be preliminarily bound to the dangling bond 12 of the base material 10. It is needless to mention that the present invention can be adequately carried out without the heating or the irradiation with UV. It is preferable to adopt a temperature or an intensity of UV not to damage the base material 10 or the lubricant film 20.

(Laser Irradiation Step)

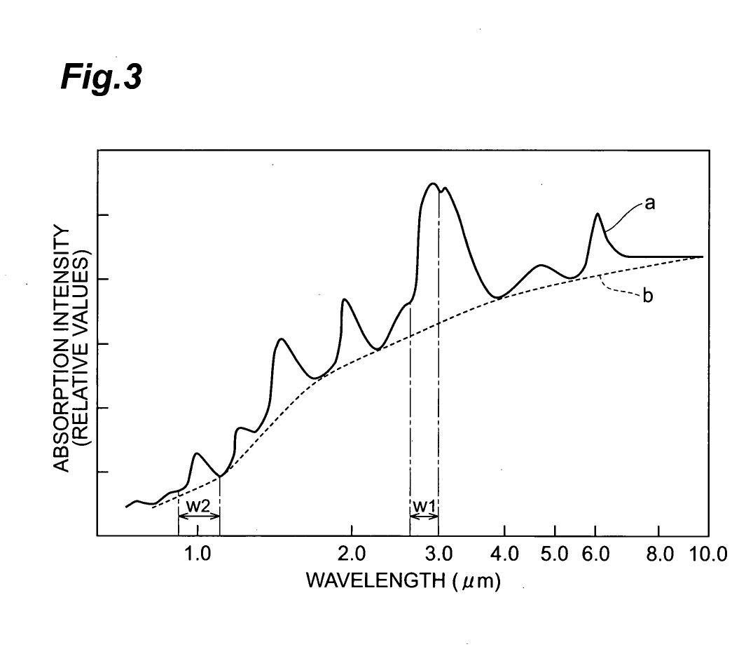

Subsequently, the lubricant 21 in the lubricant film 20 is irradiated with an infrared laser beam to excite the vibration of the OH bond of the OH group. Specifically, since the OH bond is likely to absorb infrared light, approximately, at wavelengths of about 0.9-8 μm as shown in FIG. 3, it is preferable to irradiate the lubricant with the infrared laser permitting the lubricant to absorb the energy corresponding to the wavelengths of 0.9-8 μm. In FIG. 3, dotted line b represents a base line and solid line a represents absorption intensities by the OH bond of the OH group. Particularly, it is preferable to irradiate the lubricant with the infrared laser permitting the lubricant to absorb the energy corresponding to the wavelengths of 0.9-1.2 μm (the range of W2 in FIG. 3) and 2.7-3.0 μm (the range of W1 in FIG. 3).

Specifically, in the case of single-photon absorption, the infrared laser light is, for example, an infrared laser beam of wavelengths of 0.9-8 μm and, particularly, it is an infrared laser beam of wavelengths of 0.9-1.2 μm or 2.7-3.0 μm. On the other hand, in the case of multiphoton absorption where two or more photons are absorbed, infrared laser light at a predetermined wavelength is used to make the lubricant absorb the energy corresponding to the infrared laser light of wavelengths of 0.9-8 μm and, preferably, the energy corresponding to the infrared laser light of wavelengths of 0.9-1.2 μm or 2.7-3.0 μm. For example, the multiphoton absorption is implemented by simultaneously or continuously supplying a plurality of photons the total energy of which falls in the foregoing energy range. Namely, the irradiation light in the case of multiphoton absorption has the wavelength longer than those in the case of single-photon absorption.

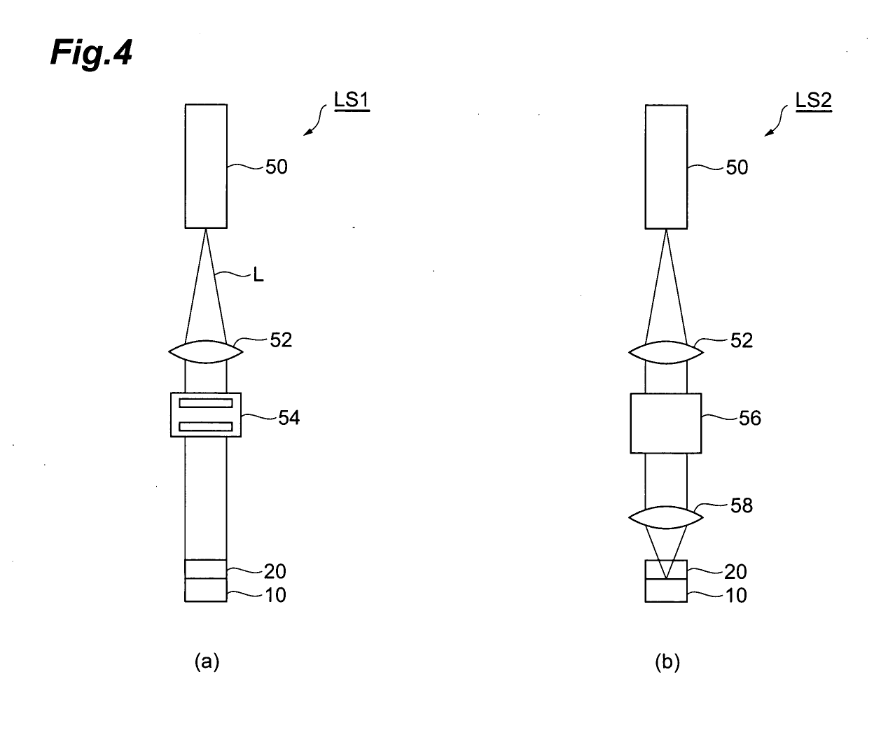

There are no particular restrictions on how to irradiate the lubricant with the infrared laser light, but the irradiation can be implemented, for example, by a laser irradiation system LS1 as shown in (a) of FIG. 4. A laser beam L from a laser light source 50 is collimated into a parallel beam by a collimator 52, a homogenizer 54 homogenizes an intensity distribution in plane, and then the lubricant 21 in the lubricant film 20 is illuminated with the homogenized beam. This form is suitably applicable, particularly, to the case where the vibration of the OH group is excited by making use of single-photon absorption. The laser light source 50 can be a CO₂ gas laser, a YAG laser, or the like.

The homogenizer 54 herein can be one of the known homogenizers, such as a combination of two lenses, or one using a diffraction grating, and it is preferably one capable of converting an in-plane intensity distribution of a Gaussian distribution type into a sufficiently flat in-plane intensity distribution.

The most effective angle of incidence of the laser beam to the lubricant film 20 is 90° as shown in (a) of FIG. 4, but the angle of incidence can be 30-60° if it is necessary to protect the light source or the like from reflected light.

The spot diameter of the infrared laser beam to irradiate the lubricant film 20 and the base material 10 can be determined corresponding to the area of the lubricant film 20. In a case where the irradiation area is very large, the beam spot may be arranged to relatively scan the lubricant film 20.

Another laser irradiation system LS2 as shown in (b) of FIG. 4 can also be contemplated. This irradiation system is suitably applicable, particularly, to multiphoton absorption such as two-photon absorption. A laser beam as a parallel beam collimated by a collimator 52 is scanned by a two-dimensional scanning optical system 56, and the scanned laser beam is focused by an objective lens 58 and projected so that it is focused on the surface of the base material 10 or on a portion of the lubricant film 20 on the base material 10 side. This can project the infrared laser beam as focused on the portion of the lubricant 21 near the interface.

The two-dimensional scanning optical system 56 is composed, for example, of two galvanomirror scanners, and is controlled by an unrepresented scanner driver to implement two-dimensional scanning on the base material with the laser spot focused on the lubricant film 20. It is a matter of course that the base material side can be moved to effect scanning.

The laser light source 50 may be the aforementioned light source, but is preferably a laser light source for supplying an ultrashort pulsed laser such as a femtosecond laser, in order to enable multiphoton absorption.

There are no particular restrictions on the irradiation intensity of the infrared laser beam in either case, but the irradiation intensity is preferably not more than 60 J/cm² in order to reduce influence on the base material and influence of evaporation or the like of the lubricant, and the irradiation intensity is preferably not less than 0.01 mJ/cm² in order to induce sufficient vibration excitation. The binding energy of the OH group is approximately 428-510 kJ/mol, and an energy over it is required to break the OH bond. However, a too strong energy will cause problems of evaporation of the lubricant, occurrence of unwanted reaction, and damage to the base material, and thus the laser irradiation energy needs to be optimized so as to match an individual sample.

In a case where the infrared laser light is a pulsed laser beam, the laser beam preferably has the irradiation intensity of not more than 60 J/cm², the pulse width of 0.1-1 ms, the pulse number of 1-10, and the frequency of pulses of 10-50 Hz in order to suppress unwanted temperature increase in the laser processing part.

It is also possible to adopt a plurality of laser light sources.

Then the irradiation with the infrared laser light as described above excites the vibration of the OH bond of the OH group in the lubricant. Therefore, it enhances the reactivity between the OH group of the lubricant 21 and the surface of the base material 10 and facilitates chemical binding of the lubricant 21 to the surface of the base material 10.

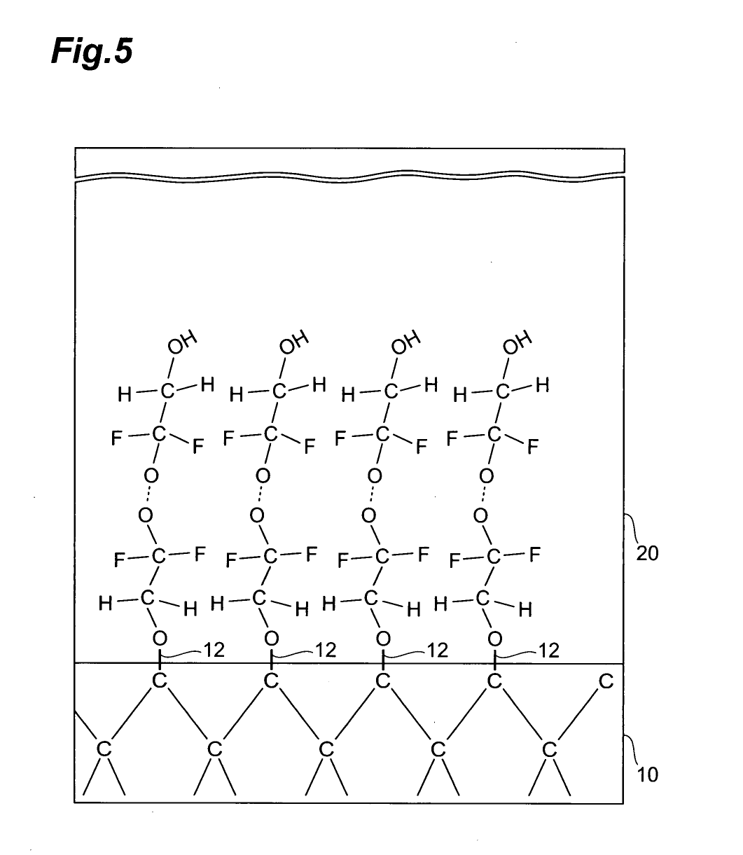

Specifically, the following mechanism can be contemplated. Namely, since the irradiation with the infrared laser light excites the vibration of the OH bond of the OH group in the lubricant 21, the OH group is activated to cause dissociation between O and H or the like and facilitate binding to the dangling bonds 12 in the surface of the base material. Therefore, the lubricant 21 can be readily covalently bound through the hydroxyl-derived O atom to the dangling bonds 12 in the surface of the base material 10, for example, as shown in FIG. 5. Therefore, this mechanism is considered to enhance the durability of the lubricant film 20.

Particularly, since the fixing method with the infrared laser light allows selective heating of the OH group as compared with the heating process, the UV process, and so on, it enables effective heating with less energy and also enables short-time processing. Therefore, it reduces thermal deterioration, thermal stress, unwanted thermal decomposition, evaporation of material, and so on. The two-photon absorption using the apparatus as shown in (b) of FIG. 4 permits, particularly, selective processing of the surface part of the base material and is thus more efficient.

The lubricant film-20 can be heated (e.g., at 80-200° C. and for 30 minutes or more) or the lubricant film 20 can be irradiated with UV, if necessary, after the irradiation with the infrared laser, so that the OH groups of the lubricant 21 or the functional groups other than the OH groups (e.g., an amino group or the like) can be subsidiarily bound to the dangling bonds 12 of the base material 10. It is needless to mention that the present invention can be adequately carried out without the heating or the irradiation with UV. It is preferable to adopt a temperature or an intensity of UV not to damage the base material 10 or the lubricant film 20.

(Cleaning Step)

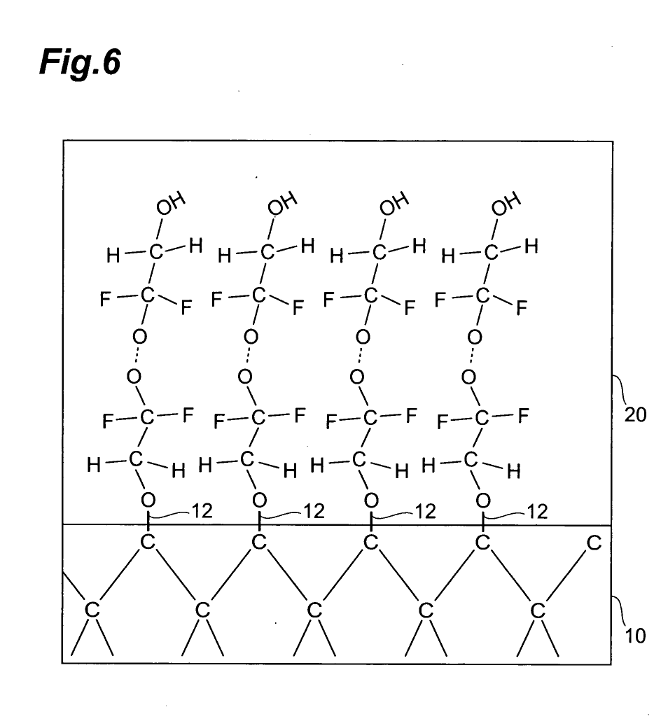

Subsequently, a cleaning step is carried out, if necessary, to remove unnecessary contents in the lubricant 21 of the lubricant film 20, i.e., the lubricant 21 not fixed to the surface of the base material 10, unwanted side products, foreign matter, free oil contents, and so on from the lubricant film 20 (cf. FIG. 6).

Specifically, the cleaning step is carried out using a cleaning medium, e.g., an organic solvent such as a fluorine-based solvent, ether, hexane, or alcohol, water, CO₂ (gas or supercritical fluid), and so on, so that the lubricant film 20 is brought into contact with one of these cleaning media. During the cleaning the lubricant film 20 may undergo supersonic vibration. When the principal purpose is removal of low-molecular substances, the cleaning can be implemented by vacuuming or heating to evaporate them.

This reduces the amount of the lubricant 21 not bound to the surface of the base material 10. There are no particular restrictions on the thickness of the lubricant film after the cleaning, but the thickness is preferably not more than 2 nm.

The lubricant can be heated (e.g., at 80-200° C. and for 30 minutes or more) or the lubricant can be irradiated with UV as described above, if necessary, after the cleaning, to bind the remaining OH groups of the lubricant or the functional groups other than them to the dangling bonds 12 in the base material 10.

This completes the lubricant film forming method according to the preferred embodiment of the present invention.

(Magnetic Head Slider and Magnetic Recording Medium)

The below will describe methods of producing a magnetic head slider and a magnetic recording medium, using the lubricant film forming method as described above.

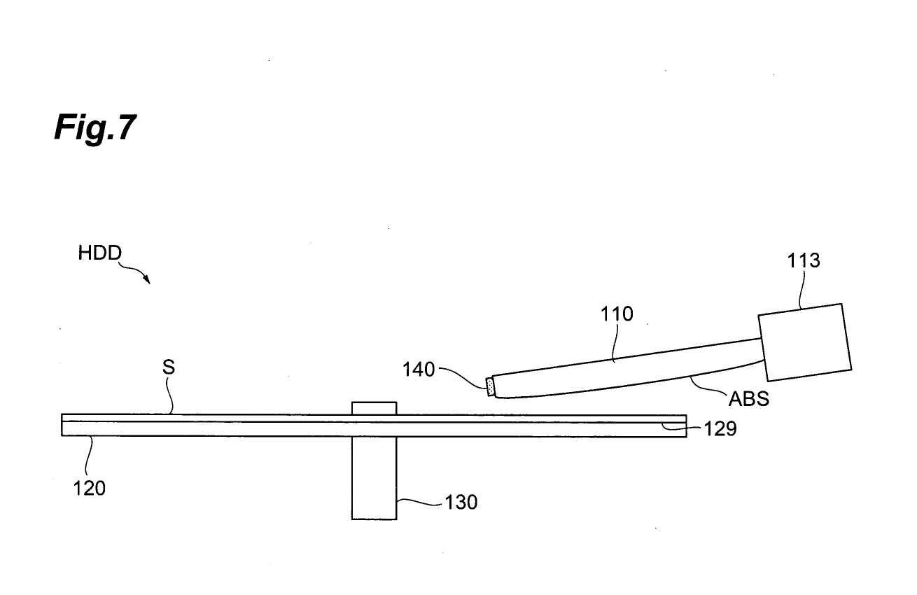

FIG. 7 is a schematic configuration diagram of a hard disk drive HDD. The hard disk drive HDD is mainly composed of a magnetic recording medium 120 of disk shape and a magnetic head slider 110.

The magnetic recording medium 120 is of disk shape and is internally provided with a magnetic recording layer 129. A motor 130 for rotating the magnetic recording medium 120 is coupled to the axial center part of the magnetic recording medium 120 and the magnetic recording medium 120 is rotated around the axis.

The magnetic head slider 110 is approximately of plate shape and is opposed to a surface S of the magnetic recording medium 120. The magnetic head slider 110 normally floats slightly above the surface S of the magnetic recording medium 120 by an airflow caused with rotation of the magnetic recording medium 120.

The magnetic head slider 110 is equipped with a magnetic head 140. The magnetic head 140 has an unrepresented writer for writing data in the magnetic recording layer 129 of the magnetic recording medium 120, and/or an unrepresented reader for reading data out of this magnetic recording layer 129. The surface of the magnetic head slider 110 opposed to the surface S of the magnetic recording medium 120 is a medium-opposed surface ABS. A head driver 113 for moving the magnetic head slider 110 to a desired place on the surface of the magnetic recording medium 120 is connected to the magnetic head slider 110.

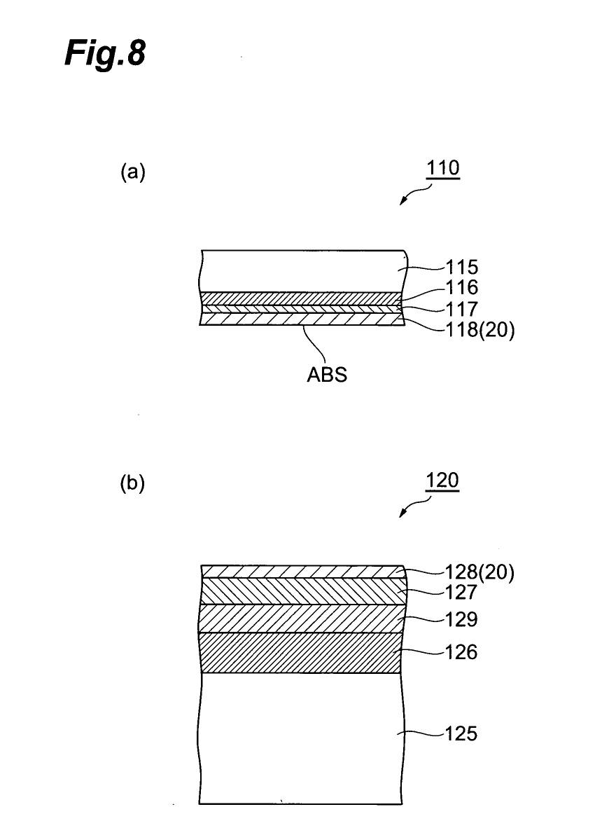

As shown in the partial sectional view of (a) of FIG. 8, the magnetic head slider 110 is constructed by forming a ground layer 116, a protecting film 117, and a lubricant film 118 on a substrate 115.

A material of the substrate 115 can be, for example, a nonmagnetic insulating material, e.g., a ceramic material such as an alumina-titanium-carbide (Al₂O₃—TiC) sintered body, a metal oxide such as alumina Al₂O₃, a metal material such as Ti, a nonmetallic inorganic material such as Si or C, or the like.

A material of the ground layer 116 can be silicon, silicon nitride, or the like.

A material of the protecting film 117 is preferably selected from carbon materials such as amorphous carbon (e.g., diamond-like carbon, graphite carbon, hydrogen-added carbon, nitrogen-added carbon, fluorine-added carbon, etc.) and carbons doped with various metals, and inorganic materials such as WC, WMoC, ZrN, BN, B₄C, SiO₂, and ZrO₂, and the protecting film 117 can be formed, for example, in the thickness of approximately 1-3 nm. In this example, the protecting film 117 corresponds to the aforementioned “base material.”

Furthermore, the lubricant film 118 corresponds to the aforementioned lubricant film 20. There are no particular restrictions on the material of the lubricant 21, but a particularly preferred material to be used is a fluorinated organic compound with an OH group such as a fluoropolyether with an OH group.

A production method of this magnetic head slider 110 is as follows: the magnetic head 140 is formed on a substrate by one of the known methods, the medium-opposed surface ABS is then formed and polished, and thereafter the ground layer 116 and protecting film 117 are formed by one of the known methods such as vapor deposition (vacuum vapor deposition, sputtering, CVD, etc.). Thereafter, the aforementioned lubricant film forming method is carried out using the protecting film 117 as the base material.

Subsequently, the magnetic recording medium 120 will be described. As shown in the partial sectional view of (b) of FIG. 8, the magnetic recording medium 120 is constructed by forming a ground layer 126, a magnetic recording layer 129, a protecting film 127, and a lubricant film 128 on a substrate 125.

A material of the substrate 125 can be, for example, glass, aluminum, Al-based alloy glass, plastic, ceramic, carbon, silicon, a Si single-crystal substrate with an oxidized surface, or the like, and, in the case of a flexible disk medium or a magnetic tape medium, the material of the substrate 125 can be, for example, a synthetic resin such as polyacetate.

There are no specific restrictions on a material of the ground film 126, and, in the case of the magnetic recording medium for hard disk, the material can be Cr, Ni—P, or the like. Furthermore, in the case of a horizontal magnetic recording medium, the material of the ground film 126 can be a nonmagnetic material such as a Cr alloy, and, in the case of a perpendicular magnetic recording medium, it can be a soft magnetic material such as a material containing Fe, Ni, and Co, or the like. Particularly, in the case of the perpendicular magnetic recording medium, the recording medium can further have another ground layer located below the soft magnetic ground layer and made of a material selected from Ti, Ta, W, Cr, Pt, or alloys containing these, or oxides and nitrides thereof, in order to improve crystallinity of the soft magnetic ground layer or in order to enhance adhesion to the substrate, and the magnetic medium can also have an intermediate layer located between the soft magnetic ground layer and the recording layer and made of a nonmagnetic material selected from Ru, Pt, Pd, W, Ti, Ta, Cr, Si, or alloys containing those, or oxides, nitrides, etc. thereof

A material of the magnetic recording layer 129 can be, for example, a material a principal component of which is Co, which contains at least Pt, which contains Cr according to need, and which further contains an oxide.

A material of the protecting film 127 can be, for example, a carbon material such as diamond-like carbon of approximately 1-10 nm. The protecting film 127 herein corresponds to the aforementioned “base material.”

Furthermore, the lubricant film 128 corresponds to the aforementioned lubricant film 20. There are no particular restrictions on the lubricant, but it is particularly preferably a fluorinated organic compound with an OH group such as a fluoropolyether with an OH group. There are no particular restrictions on the molecular weight of the fluorinated organic compound, but the center molecular weight thereof is preferably approximately from 500 to 4000.

A production method of this magnetic recording medium 120 is as follows: the ground layer 126, magnetic recording layer 129, and protecting film 127 are formed in order on the substrate 125 by the known methods, and the aforementioned lubricant film forming method is then carried out.

According to the invention as described above, the heating is not essential in particular and it is thus preferable because it can suppress thermal demagnetization or the like of the magnetic head 140 and the magnetic recording layer 129. Since the use of the magnetic head slider 110 and the magnetic recording medium 120 as described above achieves extremely high durability of the lubricant film 20, the hard disk drive is obtained with excellent reliability and lifetime. The same effect can also be enjoyed, of course, in cases where a tape medium, a flexible disk (FD), or the like is used as the magnetic recording medium.

### EXAMPLES A

### EXAMPLES A1-A3

Diamond-like carbon was deposited in vacuum to form the base material in the thickness of 3 nm on a Co substrate. Thereafter, the lubricant was applied onto the surface of the base material to obtain the lubricant film in the thickness of about 1.2 nm thereon. The lubricant used was Fomblin Z presented by Formula (1). Thereafter, the lubricant film was irradiated with a pulsed infrared laser beam of the wavelength of 1.064 μm (Nd-YAG laser). The pulse width of this laser was 0.3 ms. The laser irradiation intensity was set to 9.6, 11.6, or 13.5 J/cm² in the order of Examples A1-A3, respectively. Sample substrates with the lubricant film were obtained in this manner.

### COMPARATIVE EXAMPLE A1

A sample substrate was obtained in the same manner as in Example A1 except that the lubricant was not irradiated with the laser.

(Evaluation)

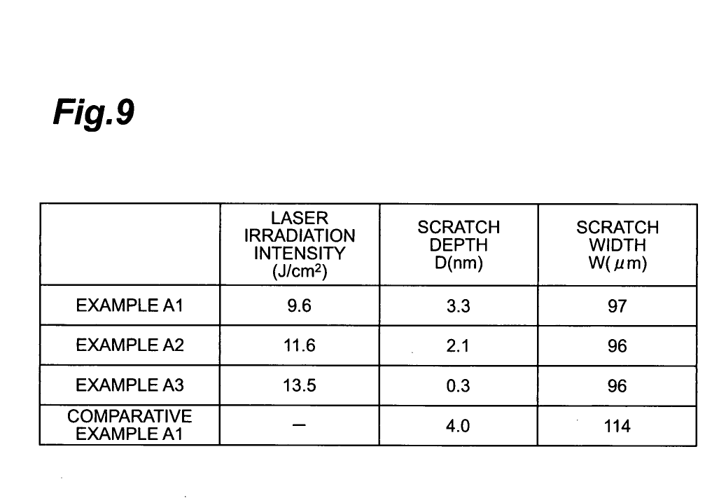

Scratch tests for the lubricant films of the respective sample substrates (in the thickness of about 1.1 nm) were conducted with an indenter having a diamond tip in the tip diameter of 8 μm and under the load of 3.98 mN. Then the depth D and width W of each scratch were measured with a scanning ellipsometer. The results are presented in FIG. 9.

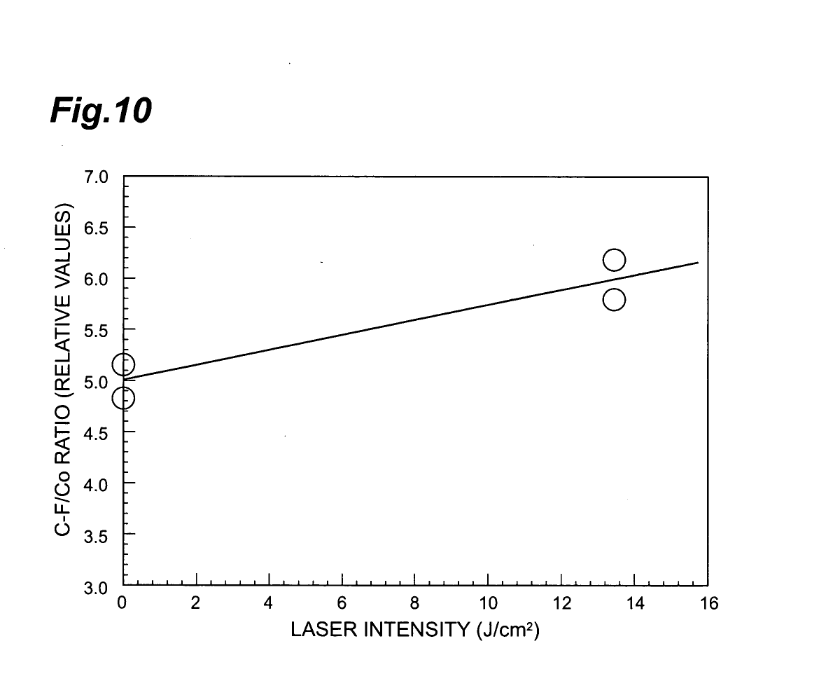

For Example A3 and Comparative Example A1, sample surfaces not used in the scratch tests were subjected to mass spectroscopy with a TOF type secondary ion mass spectrometer (SIMS) to acquire a ratio of C—F bonds characteristic to the lubricant, to Co atoms existing in the magnetic layer of the magnetic recording medium. The results are presented in FIG. 10.

As seen from FIG. 9, Examples A1-A3 exhibited sufficient durability of the lubricant film when compared with Comparative Example A1 obtained without laser irradiation.

As seen from FIG. 10, it is apparent that in Examples A1-A3 the concentration (surface adsorption density) of the lubricant fixed onto the base material is increased as compared with Comparative Example A1. Since the mass spectroscopy is carried out in vacuum, it results in evaporating the lubricant on the surface of the base material not laser-processed, i.e., the lubricant unbound to the base material. It is thus considered that the thickness of the lubricant film in Comparative Example A1 (laser intensity 0) became smaller than the thickness of the lubricant film in the laser-processed portion in the examples. Furthermore, it is considered that in the examples the laser processing resulted in causing strong reaction between diamond-like carbon as the protecting film and the lubricant molecules and increasing the surface adsorption density of lubricant molecules as compared with the comparative example.

### Second Embodiment

The below will describe a method of forming a lubricant film in only a portion of a sliding surface of a slide body on a simple flat plate for simplicity.

(Lubricant Application Step)

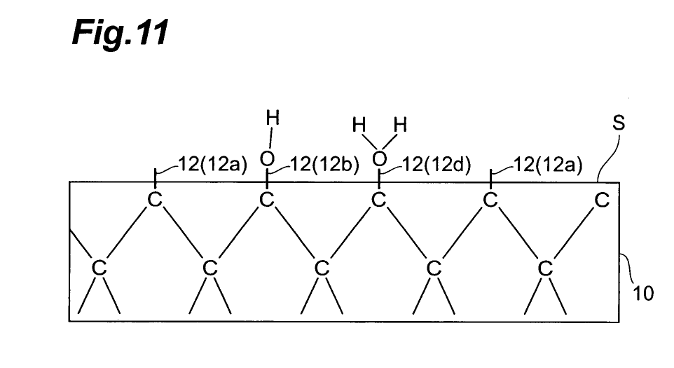

The base material as an object to be processed will be described on the basis of FIG. 11. The base material 10 has a sliding surface S that comes or can come into contact such as sliding contact with another member. There are no particular restrictions on what the base material 10 is made of. For example, the material can be selected from metals such as aluminum, aluminum alloy, and titanium; metal oxides such as alumina; ceramics such as AlTiC (Al₂O₃—TiC); inorganic materials such as silicon, glass, and carbon materials (amorphous carbon); polymer compounds such as polyethylene terephthalate, polyimide, polyamide, polycarbonate, polysulfone, polyethylene naphthalate, polyvinyl chloride, and cyclic hydrocarbon group-containing polyolefins; and so on. A film of at least one selected from NiP, NiP alloy, and other alloys can be formed on the surface of these base materials by physical vapor deposition (PVD) such as sputtering or vacuum vapor deposition, or by electroplating or the like. It is a matter of course that the base material 10 may be a multilayer structure.

The present embodiment will describe an example where the base material 10 used is diamond-like carbon (amorphous carbon) being a carbon-based protecting film prepared by CVD (chemical vapor deposition).

Normally, there are terminal bonds, called dangling bonds 12, in the surface of the base material 10. The dangling bonds 12 include those 12a not bound to any other atom, those 12b bound to an OH group, those 12c hydrogen-bound (adsorbed) to a water molecule, and so on. Of course, there are dangling bonds bound (adsorbed) to molecules other than those.

Such dangling bonds 12 do not appear only in carbon materials, but also appear in all types of solid materials. The dangling bonds are prominently seen, particularly, in materials with a strong covalently binding property.

Prior to a lubricant application step, it is preferable to detach molecules (e.g., water or the like) or functional groups (e.g., OH groups, or the like) bound to the dangling bonds 12, for example, by heating the base material 10 (e.g., at 80-200° C. and for 30 minutes or more), by irradiating the surface of the base material 10 with ultraviolet rays (e.g., at the wavelength of 50-350 nm), or by keeping the base material 10 under a reduced pressure atmosphere (e.g., 1×10⁻¹ Torr or less), under an inert gas atmosphere (e.g., nitrogen, argon, or the like), or under a low moisture environment (e.g., RH 10% or less). The heating and the irradiation with ultraviolet rays are preferably carried out in vacuum or in an inert gas such as nitrogen or argon, or in a low moisture environment (RH 10% or less). It is needless to mention that the present invention can be carried out even if there remain molecules and functional groups bound to the dangling bonds. It is preferable to adopt a heating temperature or an intensity of UV irradiation not to cause damage to the base material. It is also preferable to remove organic substances and the like on the surface by an ozone treatment.

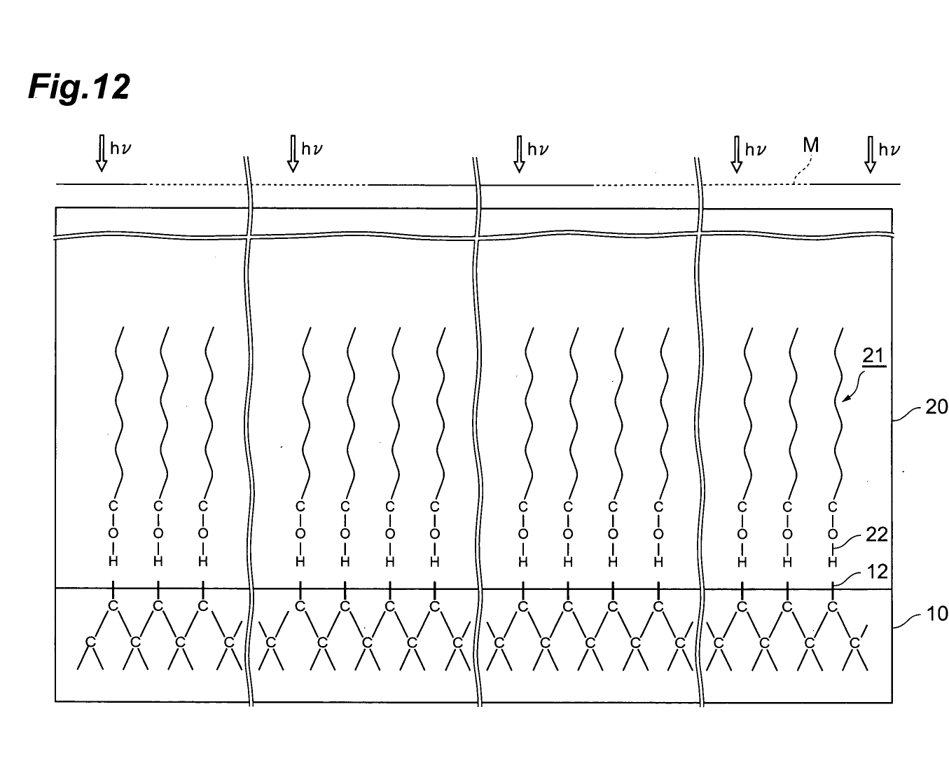

Subsequently, a step of applying the lubricant 21 onto the surface of the base material 10 to form a lubricant layer 20 will be described on the basis of FIG. 12. In FIG. 12, all the dangling bonds in the surface of the base material 10 are depicted as those not bound to another atom, but this is just for simplification; in fact, there also exist dangling bonds bound to an OH group, those hydrogen-bound (adsorbed) to a water molecule, and so on as shown in FIG. 11.

The lubricant 21 can be any compound with an OH group bound to a carbon atom. The “OH group bound to a carbon atom” stated herein is a concept embracing those contained in complicated functional groups such as a carboxyl group (—COOH) and a phenolic group.

Examples of the lubricant 21 include hydrocarbons with an OH group bound to a carbon atom and the following compounds: alcohols (e.g., erucyl alcohol, ricinolyl alcohol, arachidyl alcohol, capryl alcohol, capric alcohol, polyolefin alcohol, 2-ethylhexyl alcohol, polyalkylene glycol, etc.); carboxylic acids (e.g., aliphatic carboxylic acids, aromatic carboxylic acids, oxo carboxylic acids, etc.); esters with an OH group bound to a carbon atom (e.g., thioesters, phosphoric esters, nitric esters, etc. with an OH group bound to a carbon atom); ethers with an OH group bound to a carbon atom (e.g., polyphenylethers, dimethyl ether, ethyl methyl ether, diethyl ether, etc. with an OH group bound to a carbon atom); halogenated organic compounds with an OH group bound to a carbon atom (e.g., halogenated ethers, halogenated alcohols, halogenated carboxylic acids, etc. with an OH group bound to a carbon atom). Particularly, it is preferable to use a fluorinated organic compound with an OH group bound to a carbon atom; for example, examples of such fluorinated organic compounds include fluoroethers with an OH group bound to a carbon atom such as perfluoropolyethers with an OH group bound to a carbon atom, fluoroalcohols, carboxylic fluorides, carboxylic fluoride-alkyl esters with an OH group bound to a carbon atom, fluorodiester-dicarboxylic acid compounds with an OH group bound to a carbon atom, fluoromonoester-monocarboxylic acid compounds with an OH group bound to a carbon atom, and so on. Among these, it is particularly preferable to use a chain fluorinated organic compound with an OH group bound to a carbon atom and it is particularly preferable to use a chain fluoroether.

In particular, perfluoropolyethers with an OH group bound to a carbon atom are preferably adopted among the fluoroethers with an OH group bound to a carbon atom and, in particular, it is particularly preferable to use one of chain fluoropolyethers with an OH group bound to a carbon atom at a terminal, such as compounds represented by Formula (1) and known as Fomblin Z, compounds represented by Formula (2) and known as Fomblin Y, compounds represented by Formula (3) and known as Krytox, and compounds represented by Formula (4) and known as Demnum.

X—CF₂—O(—CF₂—CF₂—O—)ₘ(—CF₂—O—)ₙCF₂—X (1)

X—CF₂—O(—CF(CF₃)—CF₂—O—)ₘ(—CF₂—O—)ₙCF₂—X (2)

X—CF₂—O(—CF(CF₃)—CF₂—O—)ₘCF₂—CF₂—X (3)

X—CF₂—CF₂—O(—CF₂—CF₂—CF₂—O—)ₘCF₂—X (4)

In these formulae, each of m and n represents an integer of not less than 1. X represents a functional group selected from the group consisting of —CF₃, —CH₂—OH, —CH₂(—O—CH₂—CH₂—)ₚ—OH, —CH₂—O—CH(OH)—CH₂—OH, and each compound has a functional group including at least one OH group. Here P indicates an integer of not less than 1. There are no particular restrictions on the molecular weight of the chain fluoropolyethers, but the center molecular weight is preferably approximately from 500 to 4000.

It is also needless to mention that the lubricant 21 may contain a compound without an OH group bound to a carbon atom, e.g., a solvent or the like.

The application of the lubricant 21 can be implemented by one of the known methods; e.g., vacuum vapor deposition, PVD, CVD, immersion (dipping), spin coating, spray coating, and so on. In the case where the cleaning treatment such as the heating or UV irradiation in vacuum or in inert gas is carried out for the surface of the base material 10 before the application of the lubricant, this application is preferably carried out in vacuum or in inert gas in order to prevent the surface of the cleaned base material 10 from being contaminated by oxygen or water in the atmosphere, other impurities (contaminants) with high reactivity, and so on during the application.

There are no particular restrictions on the thickness of the lubricant layer 20 obtained by the application of the lubricant 21 herein, but the thickness is preferably approximately 2 nm or less, so as to permit the infrared laser to efficiently reach, particularly, the interface between the base material 10 and the lubricant layer 20 and the vicinity thereof. In the case of multiphoton absorption, there are no particular restrictions on the film thickness.

(Laser Light Irradiation Step)

The following will describe a laser light irradiation step of irradiating only a portion of a surface of the base material 10 coated with the aforementioned lubricant 21, with infrared laser light to excite the vibration of the OH bond of the OH group.

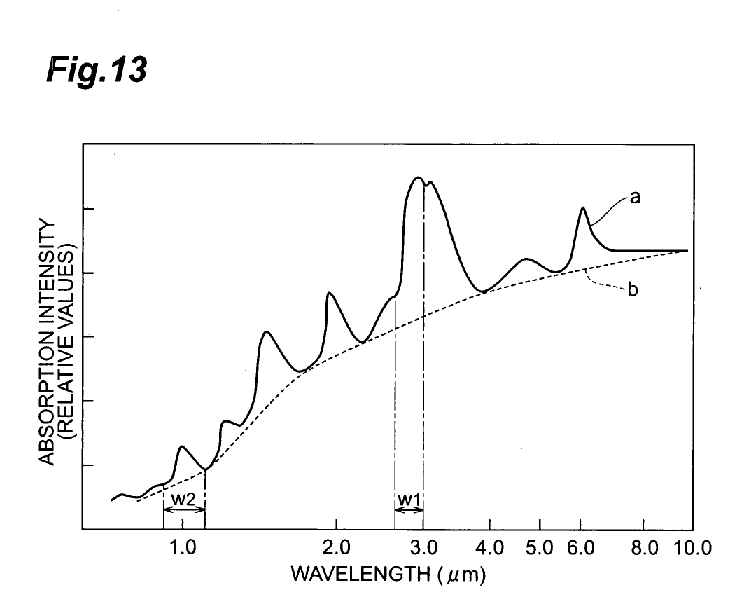

First, the infrared laser light will be described. Since the OH bond is likely to absorb infrared light, approximately, at wavelengths of about 0.9-8 μm as shown in FIG. 13, it is preferable to irradiate the lubricant with the infrared laser permitting the lubricant to absorb the energy corresponding to the wavelengths of 0.9-8 μm. In FIG. 13, dotted line b represents a base line and solid line a represents absorption intensities by the OH bond of the OH group. Particularly, it is preferable to irradiate the lubricant with the infrared laser permitting the lubricant to absorb the energy corresponding to the wavelengths of 0.9-1.2 μm (the range of W2 in FIG. 13) and 2.7-3.0 μm (the range of W1 in FIG. 13).

Specifically, in the case of single-photon absorption, the infrared laser light is, for example, an infrared laser beam of wavelengths of 0.9-8 μm and, particularly, it is an infrared laser beam of wavelengths of 0.9-1.2 μm or 2.7-3.0 μm. On the other hand, in the case of multiphoton absorption where two or more photons are absorbed, infrared laser light at a predetermined wavelength is used to make the lubricant absorb the energy corresponding to the infrared laser light of wavelengths of 0.9-8 μm and, preferably, the energy corresponding to the infrared laser light of wavelengths of 0.9-1.2 μm or 2.7-3.0 μm. For example, the multiphoton absorption is implemented by simultaneously or continuously supplying a plurality of photons the total energy of which falls in the foregoing energy range. Namely, the irradiation light in the case of multiphoton absorption has the wavelength longer than those in the case of single-photon absorption.

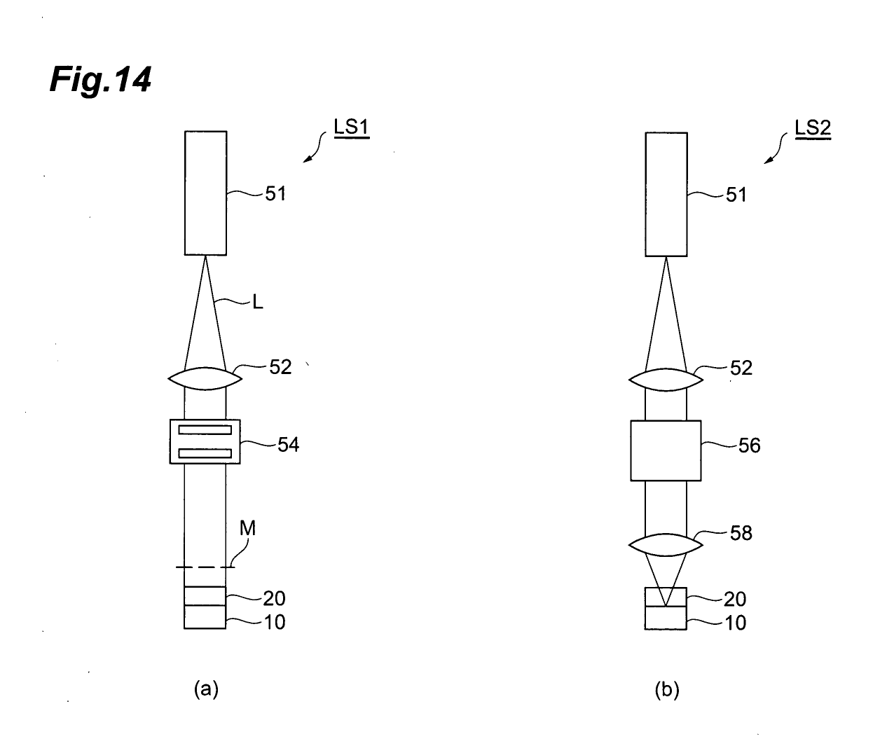

There are no particular restrictions on the irradiation with the infrared laser light, but the irradiation can be implemented, for example, by a laser irradiation system LS1 as shown in (a) of FIG. 14. A laser beam L from a laser light source 50 is collimated into a parallel beam by a collimator 52, a homogenizer 54 homogenizes an intensity distribution in plane, and then the lubricant 21 in the lubricant layer 20 is illuminated with the homogenized beam. This form is suitably applicable, particularly, to the case where the vibration of the OH group is excited by making use of single-photon absorption. The laser light source 50 can be a CO₂ gas laser, a YAG laser, or the like.

The homogenizer 54 herein can be one of the known homogenizers, such as a combination of two lenses, or one using a diffraction grating, and it is preferably one capable of converting an in-plane intensity distribution of a Gaussian distribution type into a sufficiently flat in-plane intensity distribution.

The most effective angle of incidence of the laser beam to the lubricant layer 20 is 90° as shown in (a) of FIG. 14, but the angle of incidence can be 30-60° if it is necessary to protect the light source or the like from reflected light.

The spot diameter of the infrared laser beam to irradiate the lubricant layer 20 and the base material 10 can be determined corresponding to the area of the lubricant layer 20. In a case where the irradiation area is very large, the beam spot may be arranged to relatively scan the lubricant layer 20.

Another laser irradiation system LS2 as shown in (b) of FIG. 14 can also be contemplated. This irradiation system is suitably applicable, particularly, to multiphoton absorption such as two-photon absorption. A laser beam as a parallel beam collimated by a collimator 52 is scanned by a two-dimensional scanning optical system 56, and the scanned laser beam is focused by an objective lens 58 and projected so that it is focused on the surface of the base material 10 or on a portion of the lubricant layer 20 on the base material 10 side. This can project the infrared laser beam as focused on the portion of the lubricant 21 near the interface.

The two-dimensional scanning optical system 56 is composed, for example, of two galvanomirror scanners, and is controlled by an unrepresented scanner driver to implement two-dimensional scanning on the base material with the laser spot focused on the lubricant layer 20. It is a matter of course that the base material side can be moved to effect scanning.

The laser light source 50 may be the aforementioned light source, but is preferably a laser light source for supplying an ultrashort pulsed laser such as a femtosecond laser, in order to enable multiphoton absorption.

There are no particular restrictions on the irradiation intensity of the infrared laser beam in either case, but the irradiation intensity is preferably not more than 60 J/cm² in order to reduce influence on the base material and influence of evaporation or the like of the lubricant, and the irradiation intensity is preferably not less than 0.01 mJ/cm² in order to induce sufficient vibration excitation. The binding energy of the OH group is approximately 428-510 kJ/mol, and an energy over it is required to break the OH bond. However, a too strong energy will cause problems of evaporation of the lubricant, occurrence of unwanted reaction, and damage to the base material, and thus the laser irradiation energy needs to be optimized so as to match an individual sample.

In a case where the infrared laser light is a pulsed laser beam, the laser beam preferably has the irradiation intensity of not more than 60 J/cm², the pulse width of 0.1-1 ms, the pulse number of 1-10, and the frequency of pulses of 10-50 Hz in order to suppress unwanted temperature increase in the laser processing part.

It is also possible to adopt a plurality of laser light sources.

Then the irradiation with the infrared laser light as described above excites the vibration of the OH bond of the OH group in the lubricant 21. Therefore, it enhances the reactivity between the OH group of the lubricant 21 and the surface of the base material 10 and facilitates chemical binding of the lubricant 21 to the surface of the base material 10.

Particularly, since the fixing method with the infrared laser light allows selective heating of the OH group as compared with the heating process, the UV process, and so on, it enables effective heating with less energy and also enables short-time processing. Therefore, it reduces thermal deterioration, thermal stress, unwanted thermal decomposition, evaporation of material, and so on. The two-photon absorption using the apparatus as shown in (b) of FIG. 14 permits, particularly, selective processing of the surface part of the base material and is thus more efficient.

The following will describe a method of irradiating only a portion of the surface of the base material 10 with laser light.

First, there is a method of disposing a mask M between the laser light source 50 and the lubricant layer 20, as shown in FIG. 12 and (a) of FIG. 14. This method permits the lubricant in a region irradiated with the laser light to be selectively covalently bound to the dangling bonds in the surface of the base material, and it thus becomes easier to obtain the lubricant film fixed to only a portion of the surface of the base material.

The laser irradiation system LS2 shown in (b) of FIG. 14 can also irradiate only a portion of the base material 10 with the focused laser beam.

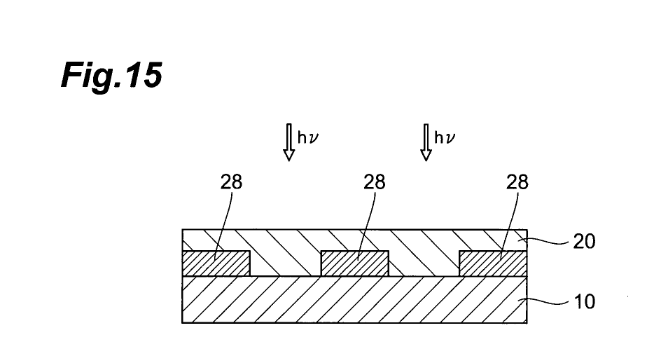

Furthermore, as shown in FIG. 15, it is also possible to adopt a method of depositing a protecting film (mask) 28 on the base material 10, applying the lubricant 21 onto it to form the lubricant layer 20, and thereafter irradiating the entire surface of the base material 10 with the laser light. This method is preferable because the border becomes clearer between the lubricant film formed by the laser irradiation, and the base material.

A constituent material of this protecting film 28 can be, for example, an amorphous carbon-based material, a ceramic material such as alumina or titanium carbide, a nonferrous metal-based material, a polymer type photoresist material, or the like.

The protecting film 28 containing such a constituent material can be formed, for example, by one of the known methods such as vapor deposition (CVD, PVD), spray coating, spin coating, and dip coating.

The protecting film 28 can be removed, for example, by one of the known methods including physical etching such as blast processing or plasma processing, chemical etching, peeling, etc., after the laser light irradiation step.

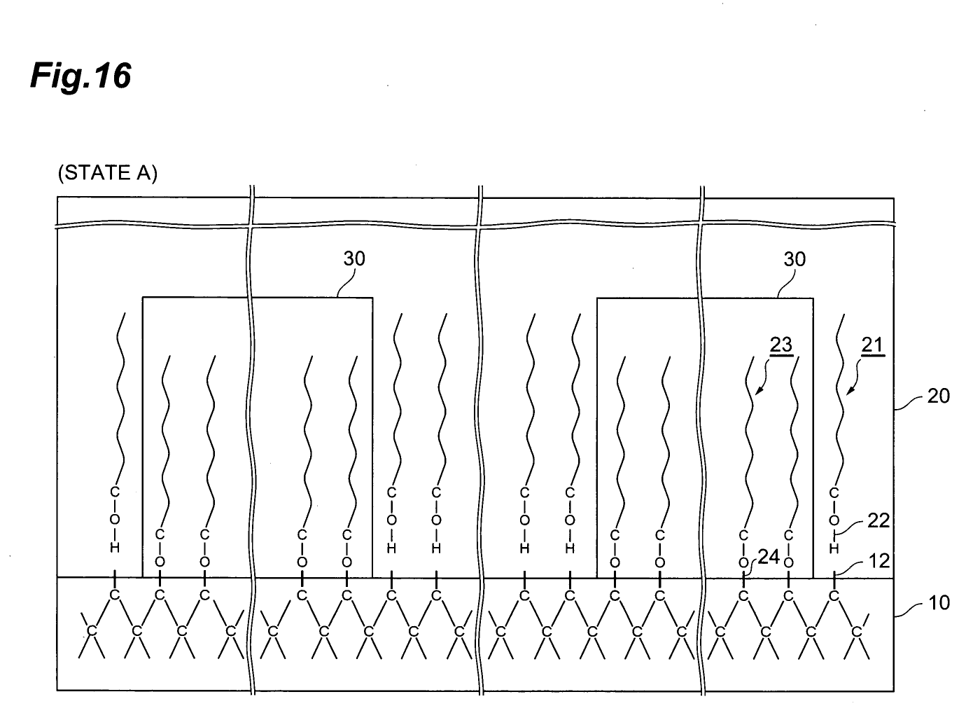

Next, a state of the lubricant 21 after the laser irradiation will be examined based on FIG. 16. Since the vibration of the OH bond of the OH group is excited in the lubricant 21 in the region irradiated with the laser light, the OH group is activated to cause dissociation between O and H or the like and facilitate binding to the dangling bonds 12 in the surface of the base material 10. Therefore, the lubricant 21 in the region irradiated with the laser light is bound through a hydroxyl-derived O atom to a dangling bond 12 in the surface of the base material 10 by a covalent bond 24, to form a molecule 23 making the lubricant film 30. The molecule 23 making the lubricant film 30 is a residue resulting from elimination of H atom from an OH group bound to a carbon atom in the lubricant 21. Therefore, where the lubricant 21 is a fluorinated organic compound, it is obviously clear that the molecule 23 making the lubricant film 30 has an organic group containing a plurality of fluorine atoms.

The lubricant layer 20 exists on both surfaces in the region where the lubricant film 30 is formed on the surface of the base material 10 and in the region where the lubricant film 30 is not formed, as shown in FIG. 16, and let us define state A as a state in which heights of the surfaces of the lubricant layer 20 are almost equal between the region where the lubricant film 30 is formed and the region where the lubricant film 30 is not formed.

The lubricant film 30 formed by the above method is preferably a plurality of dot patterns and the dot diameter thereof is preferably 0.9-100 μm. Furthermore, the density of dot patterns in the region where the dot patterns are formed is preferably 5-50% from the viewpoint of not impeding fluidity of the lubricant too much. There are no particular restrictions on the shape of dots, but it can be, for example, circular, elliptical, rectangular, fractal pattern, or the like.

The lubricant film 30 formed by the above method may be formed as a solid pattern on only a portion of the surface of the base material 10, or may be formed as a plurality of dot patterns in part or the whole of the surface of the base material 10.

The slide body with the lubricant film 30 being formed in only a portion of the sliding surface is obtained in this manner.

(Cleaning Step)

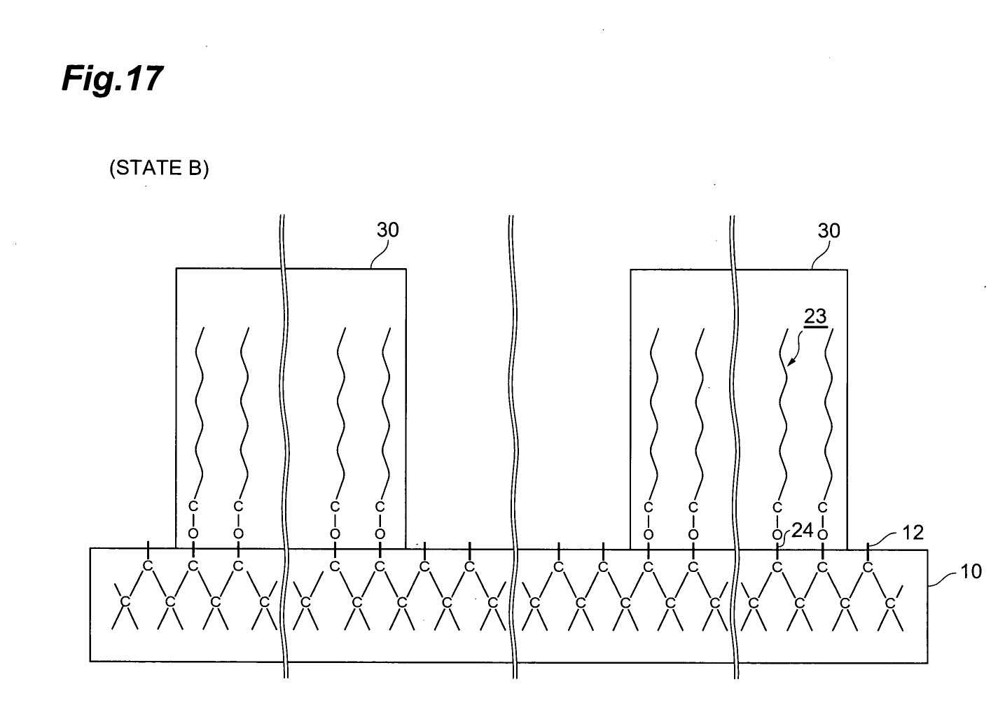

The following will describe a cleaning step, which is carried out if necessary, to remove (delube) the lubricant 21 not fixed to the surface of the base material 10, except for the molecules 23 constituting the lubricant film 30, unwanted side products, foreign matter, free oil contents, etc. from the lubricant film 30, on the basis of FIG. 17.

The cleaning step can be carried out using a cleaning medium, e.g., an organic solvent such as a fluorine-based solvent, ether, hexane, or alcohol, water, CO₂ (gas or supercritical fluid), and so on, so that the lubricant film 30 is brought into contact with one of these cleaning media. During the cleaning the lubricant film 30 may undergo supersonic vibration.

When the principal purpose is removal of low-molecular substances, the cleaning can be implemented by vacuuming or heating to evaporate them. This reduces the amount of the lubricant 21 not fixed to the surface of the base material 10. There are no particular restrictions on the thickness of the lubricant film 30 after the cleaning, but the thickness is preferably not more than 2 nm.

The remaining lubricant 21 can be heated (e.g., at 80-200° C. and for 30 minutes or more) or the lubricant 21 can be irradiated with UV, if necessary, after the cleaning, to bind the remaining OH groups of the lubricant 21 or the functional groups other than them to the dangling bonds 12 in the base material 10.

Let us define state B herein as a state in which the lubricant 21 is removed except for the lubricant film 30 as shown in FIG. 17.

(Second Lubricant Application Step)

Furthermore, the following will describe a second lubricant application step, which is carried out if necessary, to apply the lubricant 21 again onto the surface of the base material 10 after the cleaning step.

The second application of the lubricant is carried out, for example, by one of the known methods such as vapor deposition (CVD, PVD), spray coating, spin coating, and dip coating.

As the second application of the lubricant is carried out in this manner, a lubricant layer 20 with unevenness in the surface can be formed on the base material 10.

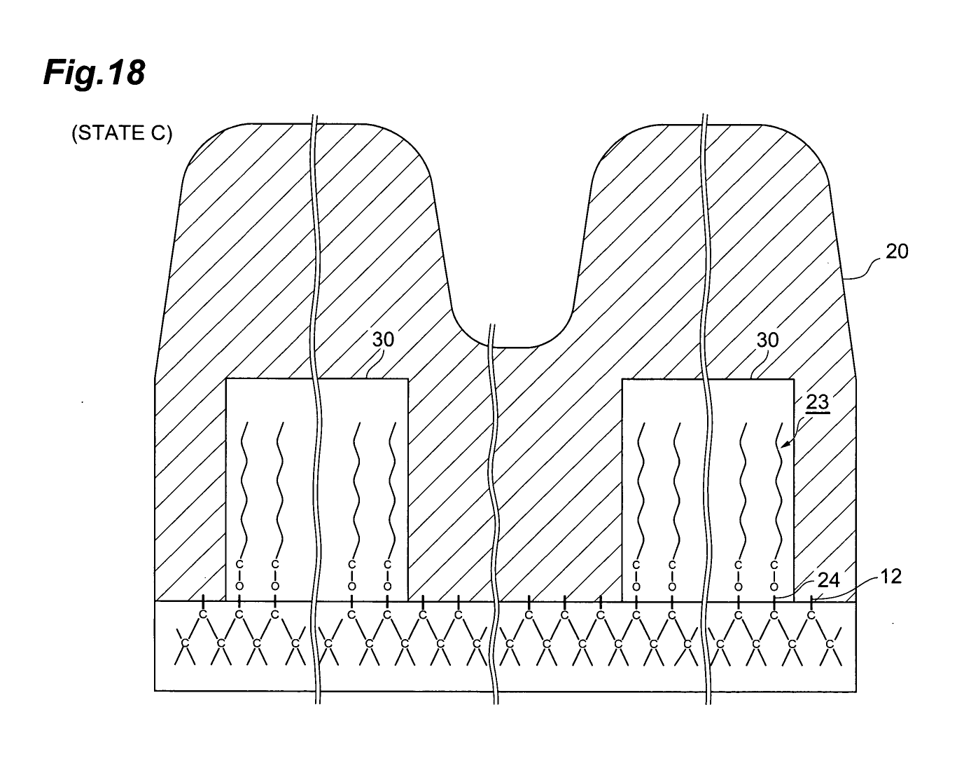

Let us define state C herein as a state in which the region with the lubricant film 30 is more outwardly projecting than the region without the lubricant film 30 on the surface of the lubricant layer 20 as shown in FIG. 18.

This completes the lubricant film forming method according to the preferred embodiment of the present invention.

The above described only the slide body on the simple flat plate for simplicity, but there are no particular restrictions on the slide body as long as it is a member that comes or can come into contact such as sliding contact with another member. Specific examples of such slide bodies include bearings with a sliding surface, e.g., sliding bearings, rolling bearings, etc., and also include the magnetic recording medium and magnetic head slider in the hard disk drive as detailed below.

[Hard Disk]

The following will describe a case where the above embodiment is applied to a hard disk.

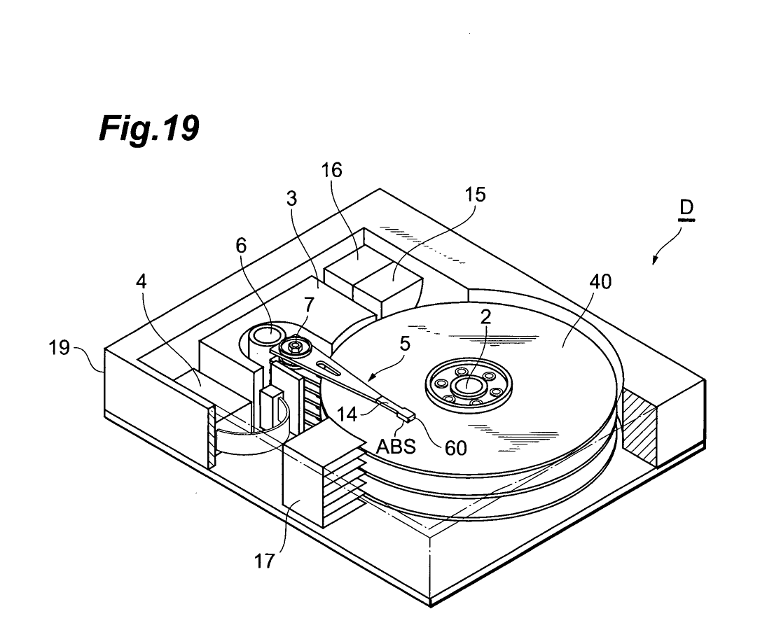

FIG. 19 is a schematic configuration diagram of a hard disk drive D according to the present embodiment. The hard disk drive D is provided with magnetic recording media 40 and magnetic head sliders 60 as described below, and is arranged to write magnetic information in sliding surfaces (the upper surfaces in FIG. 19) of the magnetic recording media 40 rotating at high speed, by the magnetic head sliders 60 and to read magnetic information out of the sliding surfaces of the magnetic recording media 40 by the magnetic head sliders 60.

In FIG. 19, the hard disk drive D is mainly composed of a plurality of magnetic recording media 40 of disk shape rotating around a shaft 2, magnetic head sliders 60 for reading and writing magnetic information into and from the magnetic recording media 40, an assembly carriage section 3 for positioning the magnetic head sliders 60 above tracks of the magnetic recording media 40, a reading/writing circuit 4 for controlling writing and reading operations at the magnetic head sliders 60, a sensor section 15 for detecting information of acceleration or the like about the hard disk drive D, a gap controller 16 for controlling gaps between the magnetic head sliders 60 and the magnetic recording media 40, a retraction section 17 as a place where the magnetic head sliders 60 are retracted from the recording media, and a housing 19 covering these members.

The assembly carriage section 3 is provided with a plurality of arms 5. These arms 5 can be angularly pivoted around a shaft 7 by voice coil motor (VCM) 6, and the arms 5 are stacked in a direction along this shaft 7. A head gimbal assembly 14 is attached to a tip of each arm 5. A magnetic head slider 60 is located at a tip of each head gimbal assembly 14 so that it faces a surface of each magnetic recording medium 40. The surface of the magnetic head slider 60 facing the surface of the magnetic recording medium 40 is defined as an air bearing surface ABS. The hard disk drive may be constructed of a single magnetic recording medium 40 and may be constructed in a configuration wherein an arm 5 is disposed relative to only one surface of each magnetic recording medium 40.

When the assembly carriage section 3 rotates an arm 5, the magnetic head slider 60 moves in a radial direction of the magnetic recording medium 40, i.e., in a direction crossing track lines. The assembly carriage section 3 is arranged to be able to rotate each arm 5 and to retract each magnetic head slider 60 to the retraction section 17, based on a signal from the outside.

[Magnetic Recording Medium]

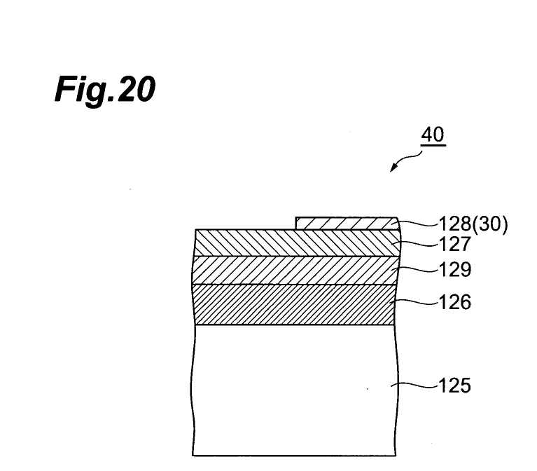

The below will describe a magnetic recording medium 40 according to the present embodiment. As shown in the partial sectional view of FIG. 20, the magnetic recording medium 40 has a structure in which a ground layer 126, a magnetic recording layer 129, a protecting film 127, and a lubricant film 128 formed in part of the surface of the protecting film 127 are laid in this order on a substrate 125.

A material of the substrate 125 can be, for example, glass, aluminum, Al-based alloy glass, plastic, ceramic, carbon, silicon, a Si single-crystal substrate with an oxidized surface, or the like, and, in the case of a flexible disk medium or a magnetic tape medium, the material of the substrate 125 can be, for example, a synthetic resin such as polyacetate.

There are no specific restrictions on the material of the ground film 126, and, in the case of the magnetic recording medium for hard disk, it can be Cr, Ni—P, or the like. Furthermore, in the case of a horizontal magnetic recording medium, the material of the ground film 126 can be a nonmagnetic material such as a Cr alloy, and, in the case of a perpendicular magnetic recording medium, it can be a soft magnetic material such as a material containing Fe, Ni, and Co, or the like. Particularly, in the case of the perpendicular magnetic recording medium, the recording medium can further have another ground layer located below the soft magnetic ground layer and made of a material selected from Ti, Ta, W, Cr, Pt, or alloys containing these, or oxides, nitrides, etc. thereof, in order to improve crystallinity of the soft magnetic ground layer or in order to enhance adhesion to the substrate, and the magnetic medium can also have an intermediate layer located between the soft magnetic ground layer and the recording layer and made of a nonmagnetic material selected from Ru, Pt, Pd, W, Ti, Ta, Cr, Si, or alloys containing those, or oxides, nitrides, etc. thereof.

A material of the magnetic recording layer 129 can be, for example, a material a principal component of which is Co, which contains at least Pt, and which contains Cr according to need, or a material which further contains an oxide.

A material of the protecting film 127 can be, for example, a carbon material such as diamond-like carbon of approximately 1-10 nm. The surface of the protecting film 127 herein corresponds to the aforementioned “surface of the base material.”

The lubricant film 128 corresponds to the aforementioned lubricant film 30. There are no particular restrictions on molecules forming the lubricant film 30, but the molecules are particularly preferably those having an organic group containing a plurality of fluorine atoms, such as a residue resulting from elimination of a H atom from an OH group in a chain fluoropolyether with an OH group bound to a carbon atom, at a terminal. There are no particular restrictions on the molecular weight of the molecules forming the lubricant film 30, but the center molecular weight thereof is preferably approximately 500-4000.

In the magnetic recording medium 40 in FIG. 20 the lubricant film 128 has no lubricant layer as in the state B of FIG. 17, but it may have a lubricant layer as in the state A of FIG. 16 or in the state C of FIG. 18.

The following will describe a region where the lubricant film 128 is preferably formed, in the magnetic recording medium 40.

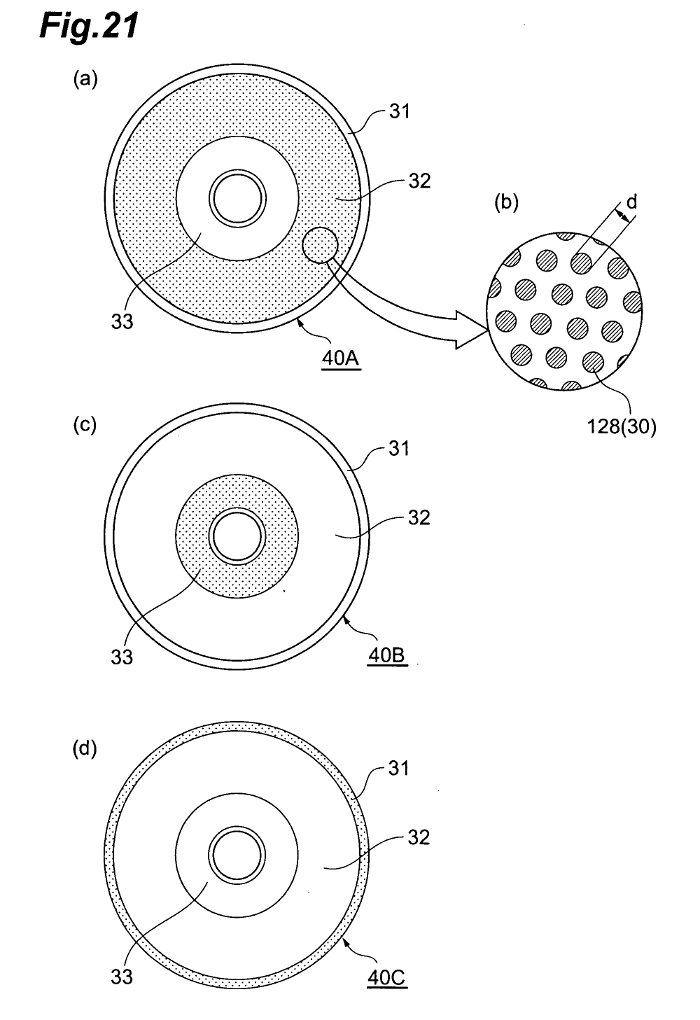

In FIG. 21(a), (c), and (d) are plan views of magnetic recording media 40 of the contact-start-stop (CSS) method viewed from the sliding surface side. The magnetic recording media of the CSS method mean those with a CSS zone 33 (corresponding to a radially inside portion) in which the magnetic head slider is in contact with the magnetic recording medium during stop times of rotation of the disk.

The magnetic recording media 40 of the present embodiment have a data section 32 (corresponding to a radially middle portion) and a peripheral section 31 (corresponding to a radially outside portion), in addition to the CSS zone 33, and the lubricant film is preferably formed as a plurality of dot patterns in at least one of these regions.

In FIG. 21, (b) is an enlarged view of dot patterns, and the dot diameter d thereof is preferably 0.9-100 μm. Concerning the shape of the dots, they are depicted in a circular shape in (b) of FIG. 21, but the shape is not limited to this shape; for example, it may be elliptical, rectangular, fractal pattern, or the like.

The magnetic recording medium 40A, in which the lubricant film 128 is formed as a plurality of dot patterns in the data section 32 as shown in (a) of FIG. 21, enjoys the following effects (1)-(4). (1) Since the lubricant film 128 has sufficient durability, the lubricant film 128 can be adequately prevented from dropping off the sliding surface in the event that the magnetic head slider 60 comes into contact with the magnetic recording medium 40 and slides thereon because of vibration, impact, or the like. (2) Since the lubricant film 128 is the plurality of dot patterns, unevenness is formed in the sliding surface, and decreases the area possibly causing contact between the magnetic recording medium 40 and the magnetic head slider 60, and, therefore, friction and abrasion can be prevented on the occasion of contact of the magnetic recording medium 40 with the magnetic head slider 60. (3) Since the lubricant film 128 is the plurality of dot patterns, unevenness is formed in the sliding surface and achieves the water repellent effect to resist adhesion of water droplets even in a high humidity environment. (4) Since the flow resistance decreases between the magnetic recording medium 40 and the magnetic head slider 60 by virtue of the water repellent effect as described in (3), as also presumed from Kaneko et al., Journal of Japan Society of Mechanical Engineers, B66-644, 139 (2000), flotation stability of the magnetic head slider 60 is achieved.

The magnetic recording medium 40B, in which the lubricant film 128 is formed as a plurality of dot patterns in the CSS section 33 as shown in (c) of FIG. 21, also enjoys the same effects (1)-(4) as in the case of the magnetic recording medium 40A.

The magnetic recording medium 40C, in which the lubricant film 30 is formed as a plurality of dot patterns in the peripheral section 31 as shown in (d) of FIG. 21, also enjoys the same effects (1)-(4) as in the case of the magnetic recording medium 40A.

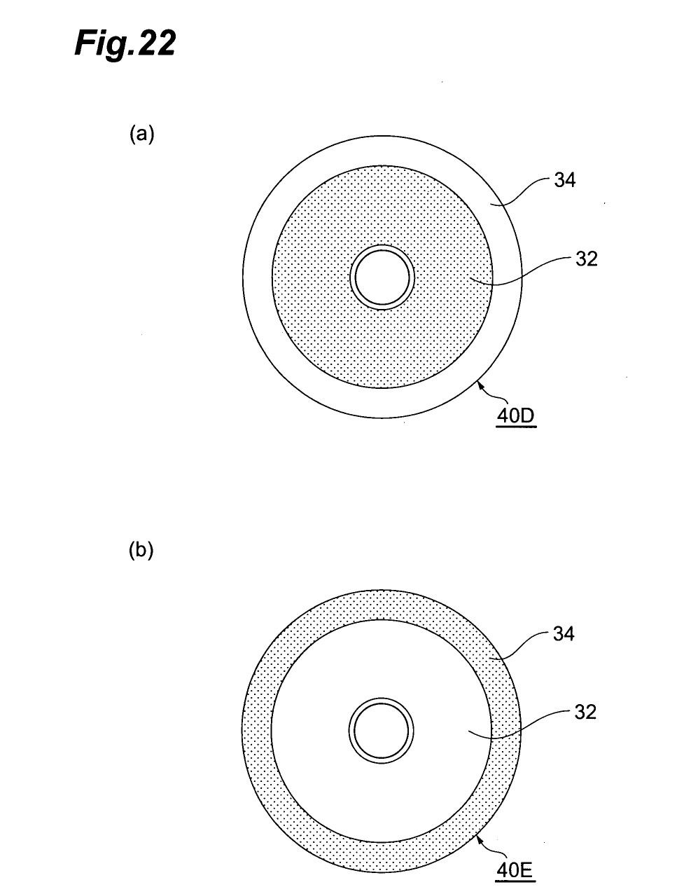

In FIG. 22, (a) and (b) are plan views of magnetic recording media 40 of the load-unload method viewed from the sliding surface side. The magnetic recording media of the load-unload method mean those wherein the magnetic head slider 60 runs up onto a ramp (not shown) located outside the outermost periphery of the magnetic recording medium 40, during stop times of rotation of the disk to retract the magnetic head slider 60 from the magnetic recording medium 40 and wherein in the outermost peripheral region there is a landing zone 34 (corresponding to a radially outside portion) used for landing the magnetic head slider 60 moving down from the ramp, onto the magnetic recording medium 40 and not used for writing of data.

The magnetic recording medium 40 of the present embodiment has a data section 32 (corresponding to a radially middle section and inside section), in addition to the landing zone 34, and a preferred configuration thereof is such that the lubricant film 128 is formed as a plurality of dot patterns in any one of these regions.

The magnetic recording medium 40D, wherein the lubricant film 128 is formed as a plurality of dot patterns in the data section 32 as shown in (a) of FIG. 22, enjoys the same effects (1)-(4) as in the case of the magnetic recording medium 40A.

The magnetic recording medium 40E, wherein the lubricant film 128 is formed as a plurality of dot patterns in the landing zone 34 as shown in (b) of FIG. 22, enjoys the same effects (1)-(4) as in the case of the magnetic recording medium 40A.

The magnetic recording media 40 wherein the lubricant film 128 is formed as a plurality of dot patterns, preferably further has a lubricant layer in which lubricant molecules physically adsorb to the sliding surface, on the region without the dot patterns and on the surfaces of the dot patterns in the sliding surface as in the state A of FIG. 16 or in the state C of FIG. 18.

This permits us to adjust the fluidity of the lubricant 21 in the lubricant layer 30 by the anchor effect of dot patterns, by adjusting the dot patterns and the density thereof. The foregoing anchor effect can prevent the lubricant 21 from moving by virtue of centrifugal force caused with rotation of the magnetic recording medium 40 so as to result in uneven thickness of the lubricant layer 30 and prevent the lubricant 21 in the thick part of the lubricant layer 30 from transferring and sticking to the magnetic head slider. Furthermore, it can suppress stiction (a phenomenon in which the magnetic head slider sticks to the magnetic recording medium) and lubricant pickup (a phenomenon in which the lubricant transfers from the magnetic recording medium to the magnetic head slider).

Furthermore, where the magnetic recording medium has the lubricant layer 30 in the state C of FIG. 18, an uneven layer of lubricant 30 is formed on the sliding surface and it enhances, particularly, the suppressing effect of stiction and lubricant pickup.

Furthermore, in the cases where the region with the plurality of dot patterns 128 is provided on only a part of the surface and where the lubricant layer 20 is present on the portion with dot patterns and on the portion without dot patterns as in FIG. 21 and FIG. 22, the fluidity of lubricant can be varied between the portion with dot patterns (e.g., CSS section 33 in (c) of FIG. 21) and the portion without dot patterns (data section 32 and peripheral section 31).

According to the production method of the magnetic recording medium 40 described above, the ground layer 126, magnetic recording layer 129, and protecting film 127 are formed in order on the substrate 125 by the known methods, and thereafter the lubricant film 128 is formed in only a part of the sliding surface by the aforementioned lubricant film forming method.

[Magnetic Head Slider]

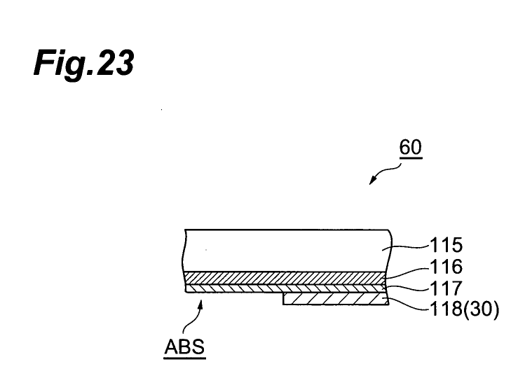

The following will describe the magnetic head slider 60 according to the present embodiment. As shown in the schematic sectional view of FIG. 23, the magnetic head slider 60 has a structure in which a ground layer 116, a protecting film 117, and a lubricant film 118 formed in part of the surface of protecting film 117 are laid in this order on a substrate 115.

A material of the substrate 115 can be, for example, a nonmagnetic insulating material, e.g., a ceramic material such as an alumina-titanium-carbide (Al₂O₃—TiC) sintered body, a metal oxide such as alumina Al₂O₃, a metal material such as Ti, a nonmetallic inorganic material such as Si or C, or the like.

A material of the ground layer 116 can be silicon, silicon nitride, or the like.

A material of the protecting film 117 is preferably selected from carbon materials such as amorphous carbon (e.g., diamond-like carbon, graphite carbon, hydrogen-added carbon, nitrogen-added carbon, fluorine-added carbon, etc.) and carbons doped with various metals, and inorganic materials such as WC, WMoC, ZrN, BN, B₄C, SiO₂, and ZrO₂, and the protecting film 117 can be formed, for example, in the thickness of approximately 1-3 nm. In this example, the surface of the protecting film 117 corresponds to the aforementioned “surface of the base material.”

The lubricant film 118 corresponds to the aforementioned lubricant film 30. There are no particular restrictions on molecules making the lubricant film 30, but a particularly preferred molecule has an organic group containing a plurality of fluorine atoms, e.g., a residue resulting from elimination of a H atom from an OH group of a chain fluoropolyether with an OH group bound to a carbon atom, at a terminal. There are no particular restrictions on the molecular weight of molecules making the lubricant film 30, but the center molecular weight thereof is preferably approximately 500-4000.

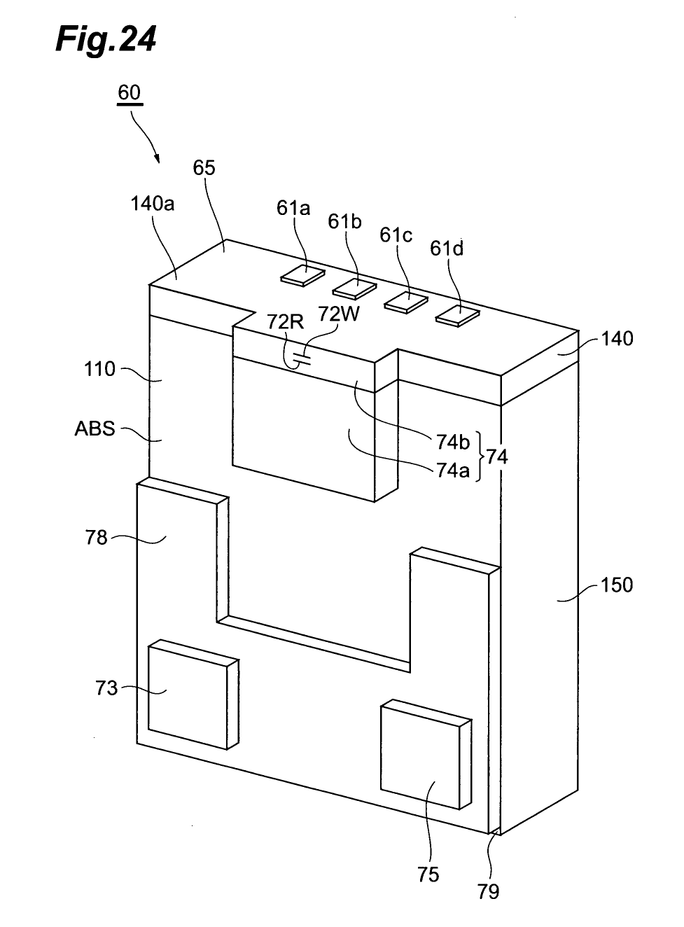

The below will describe the magnetic head slider 60 of the present embodiment, based on the perspective view of the magnetic head slider 60 shown in FIG. 24.

The magnetic head slider 60 of the present embodiment is mainly comprised of a slider 150 and a thin-film magnetic head 140 formed on an end face of the slider 150, and the magnetic head slider 60 is approximately of rectangular plate shape. The surface on this side in FIG. 24 is a counter surface opposed to the sliding surface of the magnetic recording medium 40 (cf. FIG. 19), i.e., Air Bearing Surface ABS. The air bearing surface ABS is comprised of the slider 150 and the thin-film magnetic head 140. As the magnetic recording medium 40 rotates, the magnetic head slider 60 floats up from the sliding surface of the magnetic recording medium 40 by an airflow created between the magnetic recording medium 40 and the magnetic head slider 60 with the rotation, and the air bearing surface ABS is located apart from the sliding surface of the magnetic recording medium 40. In the present embodiment, the air bearing surface ABS corresponds to the sliding surface.

The thin-film magnetic head 140 is mainly comprised of a reading element 72R for reading magnetic information from the magnetic recording medium 40, a writing element 72W for writing magnetic information into the magnetic recording medium 40, and a cover 65 made of an insulating material such as alumina, for protecting these reading element 72R and writing element 72W. In the thin-film magnetic head 140, the reading element 72R is located on the near side to a substrate 110, while the writing element 72W is located on the far side from the substrate 110.

The reading element 72R and writing element 72W can be any and suitable ones selected from the known elements. For example, the reading element 72R can be an MR element making use of the magnetoresistance effect; e.g., a GMR element, an AMR element, a TMR element, or the like. The writing element 72W can be an induction type electromagnetic transforming element provided with a magnetic circuit with a predetermined gap formed therein, and a thin-film coil surrounding the magnetic circuit.

Electrode pads 61a, 61b, 61c, and 61d are provided in this order on a surface 140a opposite to the slider 150, in the thin-film magnetic head 140.

Then the writing element 72W is electrically connected through connection lines (not shown) to the electrode pads 61a, 61b, and the reading element 72R is electrically connected through connection lines (not shown) to the electrode pads 61c, 61d.

On the air bearing surface ABS of the magnetic head slider 60 as described above, there are cavity portions 79, 110 (corresponding to the bottom portion), pad portions 73, 74, 75 (corresponding to the first projection), and a shallow portion 78 (corresponding to the second projection). The pad portions 73, 75 are formed on the air bearing surface ABS of the slider 150. The pad portion 74 is formed as ranging from on the air bearing surface of the slider 150 to on the air bearing surface of the thin-film magnetic head 140, and has a pad portion 74a formed on the air bearing surface ABS of the substrate 110 and a sensor portion (pad portion) 74b formed on the air bearing surface ABS of the thin-film magnetic head 140. These pad portions 73, 74, 75 project from the cavity portions 79, 110 toward the sliding surface of the magnetic recording medium 40. The reading element 72R and the writing element 72W are exposed in part in the surface of the sensor portion 74b.

The pad portions 73, 74, 75 project in the same height from the cavity portions 79, 110.

These pad portions 73, 74, 75 are provided for stabilizing the amount of flotation of the magnetic head slider 60 above the magnetic recording medium 40, and there are no particular restrictions on the locations, the number, and the shape of the pad portions.

The shallow portion 78 around the pad portions 73, 75 is further formed on the air bearing surface ABS of the magnetic head slider 60. The shallow portion 78 also projects from the cavity portions 79, 110 toward the magnetic recording medium 40 as the pad portions 73, 74, 75 do. The projection height of the shallow portion 78 from the cavity portions 79, 110 is lower than the height of the pad portions 73, 74, 75.

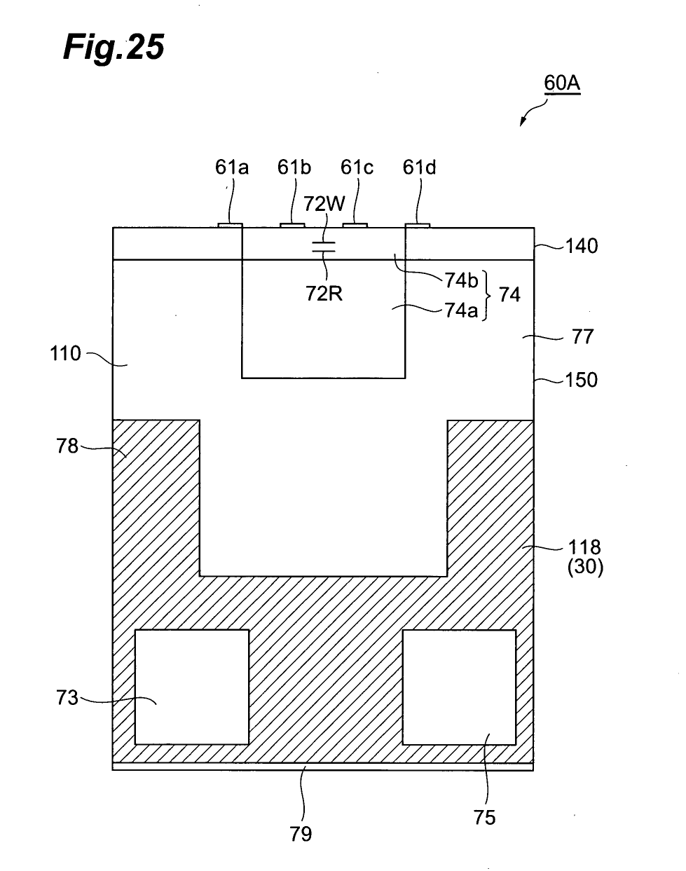

The following will describe preferred locations where the lubricant film 118 is formed, in the magnetic head slider 60, on the basis of plan views of the magnetic head slider 60 from the air bearing surface ABS, i.e., on the basis of FIGS. 25 to 28.

The magnetic head slider 60 of the present embodiment is preferably constructed as follows: the lubricant film 118 is formed on a surface of at least one of the shallow portion 78, cavity portions 79, 110, pad portions 73, 74, 75, and sensor portion 74b.

The magnetic head slider 60A, wherein the lubricant film 118 is formed on the shallow portion 78 as shown in FIG. 25, enjoys the following effects (1), (2). (1) It can prevent a head crash caused by adhesion of impurities (including the lubricant or the like from the magnetic recording medium 40) to the shallow portion 78 serving as an air inflow end during flotation. (2) When the lubricant film 118 is provided on the shallow portion 78, it can change the surface energy of the air bearing surface ABS and it changes friction resistance to air, so as to permit fine adjustment of a pitch angle of a floating posture. As a result, an improvement can be made in flotation stability of the magnetic head slider 60.

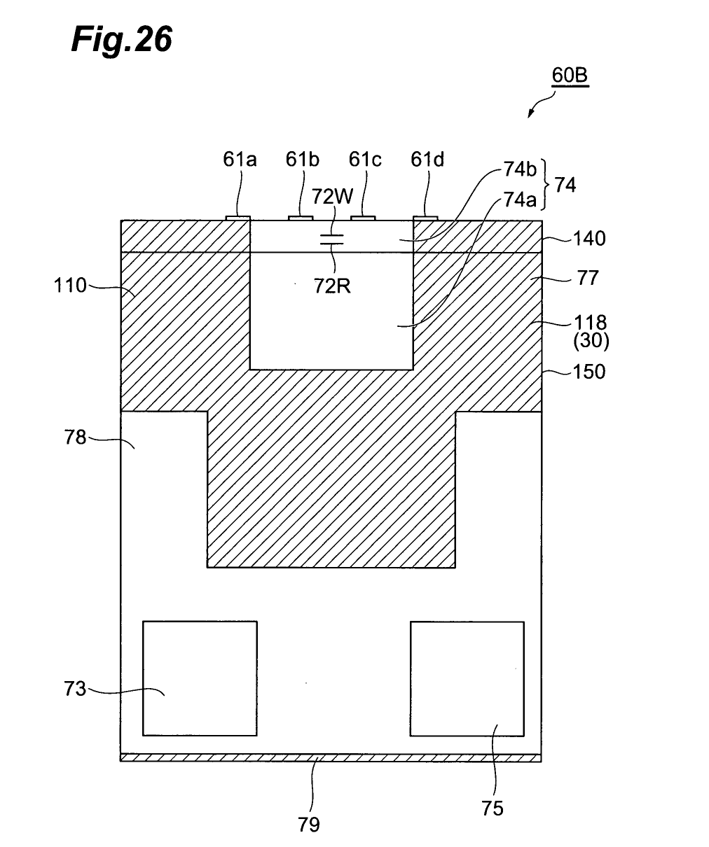

The magnetic head slider 60B, wherein the lubricant film 118 is formed on the cavity portions 79, 110 as shown in FIG. 26, enjoys the following effects (1), (2). (1) It can prevent adhesion (Fly Stiction) of impurities (including the lubricant or the like from the magnetic recording medium 40) to the cavity portions 79, 110 serving as negative pressure portions during flotation, and accumulation of those. (2) When the lubricant film is provided on the cavity portions 79, 110, it changes the surface energy of the air bearing surface ABS and it decreases friction resistance to air, so as to suppress occurrence of turbulent flow at the cavity portions 79, 110 and achieve an improvement in flotation stability.

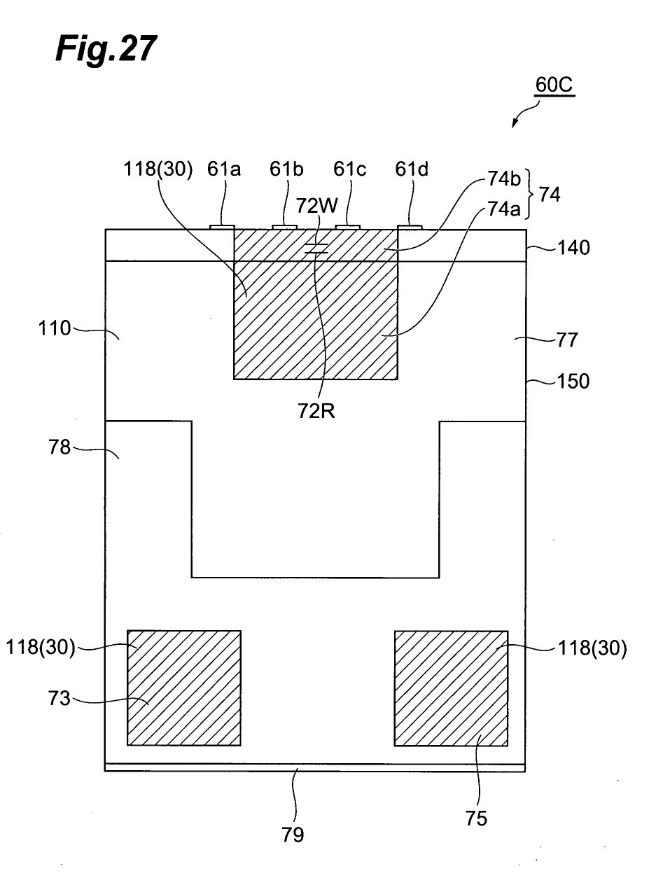

The magnetic head slider 60C, wherein the lubricant film 118 is formed on the pad portions 73, 74, 75 as shown in FIG. 27, can enjoy the following effects (1), (2). (1) It can prevent friction and abrasion of the pad portions 73, 74, 75 that can come into contact with the magnetic recording medium 40. This can decrease damage due to contact between the magnetic head slider and the magnetic recording disk caused by generation of abrasion powder and reduction of friction. (2) It can prevent stiction (a phenomenon in which the magnetic head slider sticks to the magnetic recording medium) and facilitates takeoff of the magnetic head slider 60 from the magnetic recording medium 40.

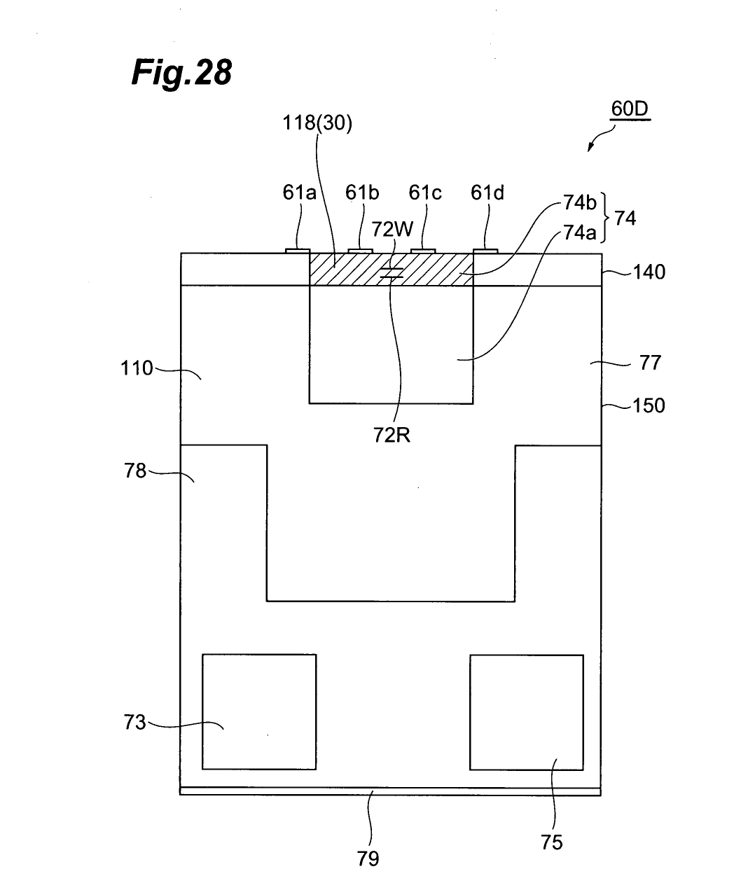

The magnetic head slider 60D, wherein the lubricant film 118 is formed on the sensor portion 74b as shown in FIG. 28, enjoys the following effects (1), (2). (1) When the lubricant film 118 is provided on the sensor portion 74b that approaches the magnetic recording medium 40 during flotation and that can come into contact therewith, damage can be reduced to the sensor portion 74b. (2) There was a problem of contact due to the narrowed gap between the magnetic recording medium 40 and the magnetic head slider 60 caused by adhesion of impurities (including the lubricant or the like from the magnetic recording medium 40) to the sensor portion 74b serving as an air outflow end during flotation. For overcoming this problem, the lubricant film 118 is provided on the sensor portion 74b, whereby the surface energy of the air bearing surface ABS can be reduced, so as to prevent the stiction (a phenomenon in which the magnetic head slider sticks to the magnetic recording medium) and the head crash.

Each lubricant film 118 described above may be formed as dot patterns or formed as a solid pattern. The magnetic recording medium 40 in FIG. 23 is constructed in the configuration wherein the lubricant film 118 has no lubricant layer as in the state B of FIG. 17, but it may have a lubricant layer as in the state A of FIG. 16 or in the state C of FIG. 18.

In the magnetic head slider 60 of the present embodiment, the lubricant film 30 is formed with the laser light, and the magnetic recording element 72W and the magnetic reading element 72R are unlikely to deteriorate with heat accordingly.

A production method of these magnetic head sliders 60 is as follows: the magnetic head 140 is formed on the substrate by the known methods, the air bearing surface ABS is formed and polished thereafter, and then the ground layer 116 and protecting film 117 are formed by the known methods such as vapor deposition (vacuum vapor deposition, sputtering, CVD, etc.). Then the aforementioned lubricant film forming method is carried out using this protecting film 117 as the base material.

### EXAMPLES B

### EXAMPLES B1-B3

Diamond-like carbon is deposited in vacuum to form the base material in the thickness of 3 nm on a Co substrate. A photoresist was deposited with a plurality of circular apertures in the diameter of 10 μm and in the thickness of 100 nm on a part of this lubricant layer. The photoresist was a novolac resin. Thereafter, a lubricant was applied onto the surface of the base material to form a lubricant layer in the thickness of about 1.2 nm on the surface of the base material. The lubricant was Fomblin Z presented by Formula (1). Thereafter, the lubricant layer was irradiated with pulsed infrared laser light of the wavelength of 1.064 μm (Nd-YAG laser). The pulse width of the laser was 0.3 ms. The laser irradiation intensity was 9.6, 11.6, or 13.5 J/cm² in the order of Examples B1-B3, respectively. Sample substrates with the lubricant film were obtained in this way.

### EXAMPLE B4

A sample substrate was obtained in the same manner as in Example B2 except that the lubricant layer was irradiated with the laser through a mask with a plurality of circular apertures in the diameter of 100 μm, instead of forming the photoresist on a part of the lubricant layer.

### COMPARATIVE EXAMPLE B1

A sample substrate was obtained in the same manner as in Example B1 except that the lubricant was not irradiated with the laser.

(Evaluation)

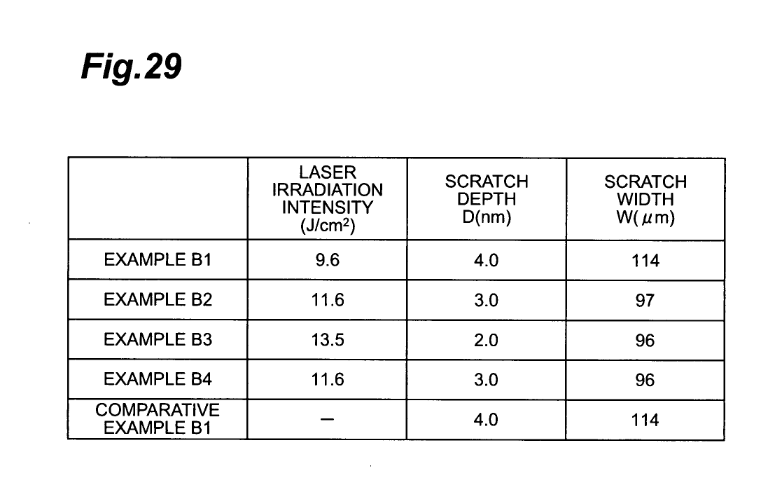

Scratch tests for the lubricant films of the respective sample substrates (in the thickness of about 1.1 nm) were conducted with an indenter having a diamond tip in the diameter of 8 μm and under the load of 3.98 mN. Then the depth D and width W of each scratch were measured with a scanning ellipsometer. The results are presented in FIG. 29.

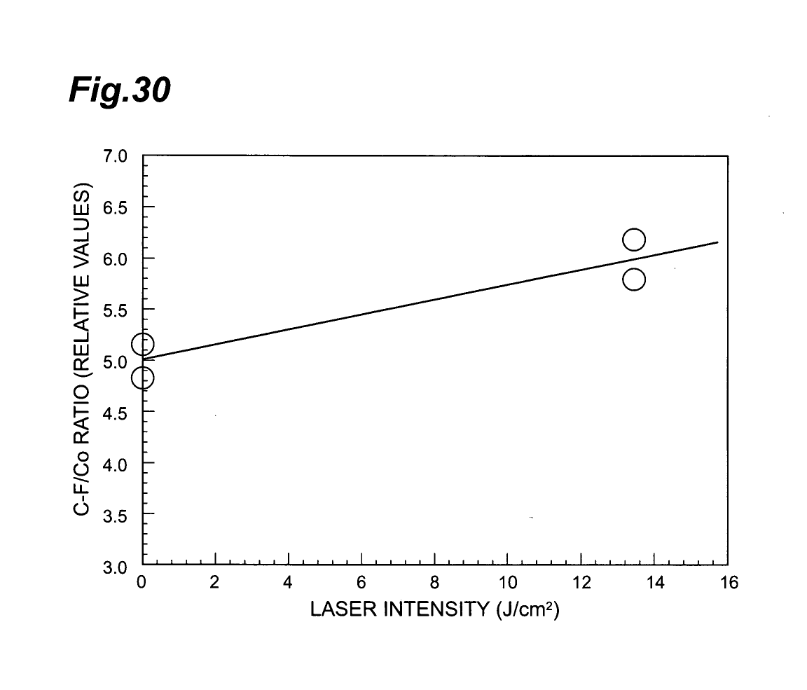

For Example B3 and Comparative Example B1, sample surfaces not used for the scratch tests were subjected to mass spectroscopy with a TOF type secondary ion mass spectrometer (SIMS) to acquire a ratio of C—F bonds characteristic to the lubricant, to Co atoms existing in the magnetic layer of the magnetic recording medium. The results are presented in FIG. 30.

As seen from FIG. 29, Examples B1-B4 exhibited sufficient durability of the lubricant film when compared with Comparative Example B1 obtained without laser irradiation.

As seen from FIG. 30, it is apparent that in Examples B1-B4 the concentration (surface adsorption density) of the lubricant fixed onto the base material is increased as compared with Comparative Example B1. Since the mass spectroscopy is carried out in vacuum, it results in evaporating the lubricant on the surface of the base material not laser-processed, i.e., the lubricant unbound to the base material. It is thus considered that the thickness of the lubricant film in Comparative Example B1 (laser intensity 0) became smaller than the thickness of the lubricant film in the laser-processed portion in the examples. Furthermore, it is considered that in the examples the laser processing resulted in causing strong reaction between diamond-like carbon as the protecting film and the lubricant molecules and increasing the surface adsorption density of lubricant molecules as compared with the comparative example.

1. A lubricant film forming method comprising a step of irradiating a lubricant with an OH group laid on a surface of a base material, with infrared laser light that excites vibration of an OH bond of the OH group.

2. The lubricant film forming method according to claim 1, wherein the step comprises irradiating the lubricant with the infrared laser light of wavelengths of 0.9-8 μm, or making the lubricant absorb an energy corresponding to the infrared laser light of wavelengths of 0.9-8 μm by multiphoton absorption with the infrared laser light.

3. The lubricant film forming method according to claim 2, wherein the step comprises irradiating the lubricant with the infrared laser light of wavelengths of 0.9-1.1 μm or of wavelengths of 2.7-3.0 μm, or making the lubricant absorb an energy corresponding to the infrared light of wavelengths of 0.9-1.1 μm or of wavelengths of 2.7-3.0 μm by multiphoton absorption with the infrared laser light.

4. The lubricant film forming method according to claim 1, wherein the step comprises irradiating the lubricant with the infrared laser light so as to implement multiphoton absorption and focus the infrared laser light on the surface of the base material or on a portion of the lubricant on the base material side.

5. The lubricant film forming method according to claim 1, wherein the infrared laser light used is infrared laser light having passed through a homogenizer.

6. The lubricant film forming method according to claim 1, wherein the lubricant is a layer having a thickness of not more than 2 nm.

7. The lubricant film forming method according to claim 1, wherein an irradiation intensity of the infrared laser light is not more than 60 J/cm².

8. The lubricant film forming method according to claim 1, wherein the infrared laser light for irradiation is an infrared pulsed laser beam, and wherein the laser beam has an intensity of not more than 60 J/cm², a pulse width of 0.1-1 ms, a pulse number of 1-10, and a frequency of pulses of 10-50 Hz.

9. The lubricant film forming method according to claim 1, wherein during irradiation with the infrared laser light, a surface temperature of the base material is kept not more than 200° C.

10. The lubricant film forming method according to claim 1, wherein the lubricant is a fluorinated organic compound with an OH group.

11. The lubricant film forming method according to claim 1, wherein the surface of the base material is made of a carbon material.

12. A method of producing a magnetic recording medium, said method comprising subjecting the lubricant laid on a surface of the magnetic recording medium, to the lubricant film forming method as set forth in claim 1.

13. A method of producing a magnetic head slider, said method comprising subjecting the lubricant laid on a surface of the magnetic head slider, to the lubricant film forming method as set forth in claim 1.

14. A lubricant film forming method comprising a laser light irradiation step of irradiating only a portion of a surface of a base material coated with a lubricant having an OH group bound to a carbon atom, with infrared laser light that excites vibration of an OH bond of the OH group, to form a lubricant film on only the portion of the surface of the base material.

15. The lubricant film forming method according to claim 14, wherein the laser light irradiation step comprises irradiating the lubricant with the infrared laser light of wavelengths of 0.9-8 μm, or making the lubricant absorb an energy corresponding to the infrared laser light of wavelengths of 0.9-8 μm by multiphoton absorption with the infrared laser light.

16. The lubricant film forming method according to claim 14, wherein the laser light irradiation step comprises irradiating the lubricant with the infrared laser light of wavelengths of 0.9-1.1 μm or of wavelengths of 2.7-3.0 μm, or making the lubricant absorb an energy corresponding to the infrared light of wavelengths of 0.9-1.1 μm or of wavelengths of 2.7-3.0 μm by multiphoton absorption with the infrared laser light.

17. The lubricant film forming method according to claim 14, wherein the laser light irradiation step comprises irradiating the lubricant with the infrared laser light so as to implement multiphoton absorption and focus the infrared laser light on the surface of the base material or on a portion of the lubricant on the base material side.

18. The lubricant film forming method according to claim 14, wherein the infrared laser light used is infrared laser light having passed through a homogenizer.

19. The lubricant film forming method according to claim 14, wherein a layer of the lubricant laid on the surface of the base material has a thickness of not more than 2 nm.

20. The lubricant film forming method according to claim 14, wherein an irradiation intensity of the infrared laser light is not more than 60 J/cm².

21. The lubricant film forming method according to claim 14, wherein the infrared laser light for irradiation is an infrared pulsed laser beam, and wherein the infrared pulsed laser beam has an intensity of not more than 60 J/cm², a pulse width of 0. -1 ms, a pulse number of 1-10, and a frequency of pulses of 10-50 Hz.

22. The lubricant film forming method according to claim 14, wherein in the laser light irradiation step, a surface temperature of the base material is kept not more than 200° C.

23. The lubricant film forming method according to claim 14, wherein the lubricant is a fluorinated organic compound.

24. The lubricant film forming method according to claim 14, wherein the surface of the base material is made of a carbon material.

25. The lubricant film forming method according to claim 14, wherein the lubricant film is a plurality of dot patterns.

26. The lubricant film forming method according to claim 25, wherein the dot patterns have a diameter of 0.9-100 μm.

27. The lubricant film forming method according to claim 14, further comprising a cleaning step of removing the lubricant not fixed to the surface of the base material, after the laser light irradiation step.

28. The lubricant film forming method according to claim 27, further comprising a second lubricant application step of applying the lubricant onto the surface of the base material, after the cleaning step.

29. A slide body wherein a lubricant film is formed on only a portion of a sliding surface,
wherein a molecule forming the lubricant film has a C—O bond, and
wherein an O atom of the C—O bond is bound through a covalent bond to an atom of the sliding surface.

30. The slide body according to claim 29, wherein the molecule forming the lubricant film has an organic group containing a plurality of fluorine atoms.

31. The slide body according to claim 29, wherein the sliding surface is made of a carbon material.

32. The slide body according to claim 29, wherein the lubricant film is a plurality of dot patterns.

33. The slide body according to claim 32, wherein the dot patterns have a diameter of 0.9-100 μm.

34. The slide body according to claim 32, the slide body having a lubricant layer wherein lubricant molecules physically adsorb to a portion without the dot patterns in the sliding surface and to surfaces of the dot patterns.

35. The slide body according to claim 34, wherein a surface of the lubricant layer in a portion with the dot patterns is more outwardly projecting than a surface of the lubricant layer in the portion without the dot patterns.

36. A magnetic recording medium comprising the slide body as set forth in claim 29, and having a magnetic recording layer in the slide body.

37. The magnetic recording medium according to claim 36, wherein the slide body is of a disk shape, and wherein the lubricant film is formed in an annular region located in at least one of a radially inside portion, a radially middle portion, and a radially outside portion in the slide surface of the disk shape.

38. A magnetic head slider comprising the slide body as set forth in claim 29, and having a magnetic recording element and/or a magnetic reading element disposed on the sliding surface.

39. The magnetic head slider according to claim 38, wherein the sliding surface has a bottom portion and a first projection projecting from the bottom portion, and wherein the lubricant film is provided on a surface of either one of the bottom portion and the first projection.

40. The magnetic head slider according to claim 38, wherein the sliding surface includes a bottom portion, a first projection projecting from the bottom portion, and a second projection provided around the first projection and being lower than the first projection and higher than the bottom portion, and wherein the lubricant film is provided on a surface of at lease one of the first projection, the bottom portion, and the second projection.

41. The magnetic head slider according to claim 38, wherein the lubricant film is provided on a surface of a sensor portion including the magnetic recording element and/or magnetic reading element.

42. A hard disk drive comprising:
the magnetic recording medium as set forth in claim 36; and
a magnetic head slider comprising the slide body wherein a lubricant film is formed on only a portion of a sliding surface,
wherein a molecule forming the lubricant film has a C—O bond and
wherein an O atom of the C—O bond is bound through a covalent bond to an atom of the sliding surface and having a magnetic recording element and/or a magnetic reading element disposed on the sliding surface.
